(19) United States
(12) Patent Application Publication
(10) Pub. No.: US 2024/0319083 A1
(43) Pub. Date: Sep. 26, 2024

(54) APPARATUS FOR TIME-RESOLVED FLUORESCENCE MEASUREMENT USING BANDWIDTH-LIMITED DIGITAL-PULSE LIGHT MODULATION AND METHODS

(71) Applicant: The Board of Regents of the University of Oklahoma, Norman, OK (US)

(72) Inventors: Javier A. Jo, Norman, OK (US); Michael J. Serafino, Los Angeles, CA (US)

(21) Appl. No.: 18/611,339

(22) Filed: Mar. 20, 2024

Related U.S. Application Data
(60) Provisional application No. 63/491,197, filed on Mar. 20, 2023.

(51) Int. Cl. G01N 21/31; G01N 21/17; G01N 21/64

(52) U.S. Cl. CPC G01N 21/314; G01N 21/6486; G01N 2021/1789; G01N 2021/3148

(57) ABSTRACT

A system and method for analyzing biological samples (e.g., epithelial tissues) is described herein, including a multispectral frequency-domain time-resolved fluorescence measuring system comprising a frequency-modulated continuous wave digital-pulse modulated diode laser (FM CW laser) and a light emission detector. The FM CW laser is configured for simultaneous multiwavelength excitation of a compound. The light emission detector is configured for simultaneous multispectral time-resolved fluorescence measurement of a fluorescence frequency response (FFR) of the compound. The compound may be in an epithelial tissue. The excitation is modulated at frequencies within a frequency range of less than 100 MHz. The FM CW laser may be configured to emit modulated excitation spanning a set of frequencies which comprises at least three different frequencies in a range between 1 to 99 MHz, the set comprising at least one frequency <50 MHz, and at least one frequency ≥50 MHz and <100 MHz.

### CROSS-REFERENCE TO RELATED APPLICATIONS

This application claims priority to the provisional patent application identified by U.S. Ser. No. 63/491,197, filed Mar. 20, 2023, the entire content of which is hereby expressly incorporated herein by reference.

### BACKGROUND

Time-resolved fluorescence (TRF) measurements required to measure fluorescence lifetimes can be performed in either the time-domain (TD) or the frequency-domain (FD). TD-TRF measurements require pulsed light sources, high-bandwidth (e.g., 1-2 Gigahertz (GHz)) photodetectors, and electronics/digitizers. FD-TRF measurements require light-sources that can be modulated at intermediate frequencies (e.g., hundreds of Megahertz (MHz)), and medium-bandwidth (e.g., hundreds of MHz) photodetectors and electronics/digitizers. These requirements make the implementation of TRF measurement systems time-resolved fluorescence spectroscopy (TRFS) and fluorescence lifetime imaging microscopy (FLIM) instruments costly and difficult to scale up. Due to the complexity, limited practicality, and cost of conventional FLIM instrumentation, FLIM adoption has been mostly limited to academic settings.

### BRIEF DESCRIPTION OF THE DRAWINGS

Several embodiments of the present disclosure are hereby illustrated in the appended drawings. It is to be noted however, that the appended drawings only illustrate several typical embodiments and are therefore not intended to be considered limiting of the scope of the inventive concepts disclosed herein. The patent or application file contains at least one drawing executed in color. Copies of this patent or patent application publication with color drawing(s) will be provided by the Office upon request and payment of the necessary fee.

FIG. 1 is a diagrammatic view of an exemplary embodiment of an FD-FLIM system constructed in accordance with the present disclosure.

FIG. 2 is a diagrammatic view of an exemplary embodiment of a computing device shown in FIG. 1.

FIG. 3 is a diagrammatic view of an exemplary embodiment of a host computer shown in FIG. 1.

FIG. 4A is a diagrammatic view of a plurality of exemplary in vivo images of human index-finger tip skin in accordance with the present disclosure.

FIG. 4B is a diagrammatic view of a plurality of exemplary in vivo images of human tongue mucosa in accordance with the present disclosure.

FIG. 5A is a diagrammatic view of exemplary clocking and data relationships between an FPGA and a digitizer constructed in accordance with the present disclosure.

FIG. 5B is a diagrammatic view of an exemplary digitizer interface for an FPGA for acquiring a differential pair of data lines in accordance with the present disclosure.

FIG. 6A is a graphical view of an exemplary modulation lifetime τₘ error at f_{≈DC}³⁷⁵=1.82 MHz in accordance with the present disclosure.

FIG. 6B is a graphical view of an exemplary modulation lifetime τₘ error at f_{≈DC}⁴⁴⁵=2.02 MHz in accordance with the present disclosure.

FIG. 7A is a diagrammatic view of an exemplary embodiment of DFT processing logic constructed in accordance with the present disclosure.

FIG. 7B is a diagrammatic view of an exemplary embodiment of a DFT module shown in FIG. 7A.

FIG. 7C is a diagrammatic view of an exemplary embodiment of a twiddle generator shown in FIG. 7B.

FIG. 7D is a diagrammatic view of an exemplary embodiment of a DFT submodule shown in FIG. 7B.

FIG. 7E is a diagrammatic view of an exemplary embodiment of a serializer shown in FIG. 7A.

FIG. 8 is a diagrammatic view of an exemplary method of analyzing an epithelial tissue in accordance with the present disclosure.

### DETAILED DESCRIPTION

The present disclosure is directed to a novel TRF measurement system and method that relies on light-sources that can be modulated at frequencies substantially less than 100 MHz, and photodetectors and electronics with modest bandwidth (e.g., ˜100 MHz). This novel, TRF measurement technique enables the construction and use of versatile, practical, cost-effective, and scalable TRFS and FLIM instruments.

In one aspect, the present disclosure includes a multispectral frequency-domain time-resolved fluorescence (FD-TRF) measuring system, comprising: one or more frequency-modulated (FM) continuous wave (CW) digital-pulse modulated diode laser configured for simultaneous multiwavelength excitation of one or more compounds and one or more light emission detector configured for simultaneous multispectral time-resolved fluorescence measurement of a fluorescence frequency response (FFR) of the one or more compound, wherein the excitation is modulated at frequencies within a frequency range of less than 100 MHz, wherein the one or more diode laser is configured to emit modulated excitation spanning a set of frequencies which comprises at least three different frequencies in a range between 1 to 99 MHz, the set comprising at least one frequency <50 MHz, and at least one frequency ≥50 MHz and <100 MHz.

In another aspect, the present disclosure includes a method of analyzing a biological sample, comprising: providing a multispectral frequency-domain time-resolved fluorescence (FD-TRF) measuring system, wherein the FD-TRF measuring system comprises one or more frequency-modulated (FM) continuous wave (CW) digital-pulse modulated diode laser configured for simultaneous multiwavelength excitation of one or more compound and one or more light emission detector configured for simultaneous multispectral time-resolved fluorescence measurement of a fluorescence frequency response (FFR) of the one or more compound, wherein the excitation occurs at wavelengths within a frequency range of less than 100 MHz, wherein the one or more diode laser is configured to emit excitation at wavelengths spanning a set of frequencies which comprises at least three different frequencies in a range between 1 to 99 MHz, the set comprising at least one frequency <50 MHz, and at least one frequency ≥50 MHz and <100 MHz; and using the FD-TRF measuring system to irradiate the biological sample, for example to determine if the biological sample is cancerous. The biological sample may be an epithelial tissue.

The temporal dynamics characteristics of fluorescence emission of a sample or compound can be quantified in terms of the sample's fluorescence impulse response (FIR) or fluorescence frequency response (FFR). The fluorescence emission lifetimes can be as short as a few hundreds of picoseconds (ps), which would correspond to FFR with bandwidths in the GHz. Fluorescence lifetimes as short as 400 ps can be estimated from the incomplete FFR measured at only three discrete frequencies below 100 MHz. Based on these observations, a FD-TRF measurement technique is described that utilizes digital-pulse modulated light sources which enables interrogating the FFR at multiple discrete frequencies (i.e., at the fundamental frequency and harmonics of the digital-pulse modulation signal) covering a modest frequency range (e.g., ˜1-100 MHz). Moreover, the band-limited modulated fluorescence emission can be measured with inexpensive photodetectors and electronics/digitizers. The simplicity and cost-efficiency of this novel FD-TRF measurement technique enable customizable and scalable TRFS and FLIM instruments with versatile specifications, such as simultaneous multi-wavelength excitation and multi-spectral emission detection.

Before describing various embodiments of the present disclosure in more detail by way of exemplary description, examples, and results, it is to be understood that the embodiments of the present disclosure are not limited in application to the details of methods and compositions as set forth in the following description. The embodiments of the present disclosure are capable of other embodiments or of being practiced or carried out in various ways. As such, the language used herein is intended to be given the broadest possible scope and meaning; and the embodiments are meant to be exemplary, not exhaustive. Also, it is to be understood that the phraseology and terminology employed herein is for the purpose of description and should not be regarded as limiting unless otherwise indicated as so. Moreover, in the following detailed description, numerous specific details are set forth in order to provide a more thorough understanding of the disclosure. However, it will be apparent to a person having ordinary skill in the art that the presently disclosed inventive concepts may be practiced without these specific details. In other instances, features which are well known to persons of ordinary skill in the art have not been described in detail to avoid unnecessary complication of the description.

Unless otherwise defined herein, scientific and technical terms used in connection with the embodiments of the present disclosure shall have the meanings that are commonly understood by those having ordinary skill in the art. Further, unless otherwise required by context, singular terms shall include pluralities and plural terms shall include the singular.

All patents, published Patent Applications, and non-patent publications mentioned in the specification, including but not limited to U.S. Ser. No. 63/491,197, are indicative of the level of skill of those skilled in the art to which embodiments of the present disclosure pertain. All patents, published Patent Applications, and non-patent publications referenced in any portion of this application are herein expressly incorporated by reference in their entirety to the same extent as if each individual patent or publication was specifically and individually indicated to be incorporated by reference.

While the apparatus and methods of the embodiments of the present disclosure have been described in terms of particular embodiments, it will be apparent to those of skill in the art that variations may be applied to the apparatus and/or methods and in the steps or in the sequence of steps of the method described herein without departing from the spirit and scope of the inventive concepts. All such similar substitutes and modifications apparent to those of skilled in the art are deemed to be within the spirit and scope of the inventive concepts as defined herein.

As utilized in accordance with the apparatus and methods of the embodiments of the present disclosure, the following terms, unless otherwise indicated, shall be understood to have the following meanings:

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or when the alternatives are mutually exclusive, although the disclosure supports a definition that refers to only alternatives and “and/or.” The use of the term “at least one” will be understood to include one as well as any quantity more than one, including but not limited to, 2, 3, 4, 5, 6, 7, 8, 9, 10, 15, 20, 30, 40, 50, 100, or any integer inclusive therein. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

Throughout this application, the term “about” or “approximately” is used to indicate that a value includes the inherent variation of error. Further, in this detailed description, each numerical value (e.g., time or frequency) should be read once as modified by the term “about” (unless already expressly so modified), and then read again as not so modified unless otherwise indicated in context. The use of the term “about” or “approximately” may mean the number ±1%, or ±5%, or ±10%, or ±15%, or ±20%,unless otherwise stated.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Also, any range listed or described herein is intended to include, implicitly or explicitly, any number within the range, particularly all integers, including the end points, and is to be considered as having been so stated. For example, “a range from 1 to 50” is to be read as indicating each possible number, particularly integers, along the continuum between about 1 and about 50. Thus, even if specific data points within the range, or even no data points within the range, are explicitly identified or specifically referred to, it is to be understood that any data points within the range are to be considered to have been specified, and that the inventors possessed knowledge of the entire range and the points within the range. Thus, to illustrate, reference to a numerical range, such as 1-10 includes 1, 2, 3, 4, 5, 6, 7, 8, 9, 10, as well as 1.1, 1.2, 1.3, 1.4, 1.5, etc., and so forth. Reference to a range of 1-50 therefore includes 1, 2, 3, 4, 5, 6, 7, 8, 9, 10, 11, 12, 13, 14, 15, 16, 17, 18, 19, 20, etc., up to and including 50, as well as 1.1, 1.2, 1.3, 1.4, 1.5, etc., 2.1, 2.2, 2.3, 2.4, 2.5, etc., and so forth. Reference to a series of ranges includes ranges which combine the values of the boundaries of different ranges within the series. Thus, to illustrate reference to a series of ranges, for example, of 1-10, 10-20, 20-30, 30-40, 40-50, 50-60, 60-75, 75-100, 100-150, 150-200, 200-250, 250-300, 300-400, 400-500, 500-750, 750-1,000, includes ranges of 1-20, 10-50, 50-100, 100-500, and 500-1,000, for example.

As noted above, any numerical range listed or described herein is intended to include, implicitly or explicitly, any number or sub-range within the range, particularly all integers, including the end points, and is to be considered as having been so stated. For example, “a range from 1.0 to 50.0” is to be read as indicating each possible number, including integers and fractions, along the continuum between and including 1.0 and 50.0, that is, having a minimum value equal to or greater than 1.0 and a maximum value equal to or less than 50.0, such as, for example, 3.25 to 38.65. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. Thus, even if specific data points within the range, or even no data points within the range, are explicitly identified or specifically referred to, it is to be understood that any data points within the range are to be considered to have been specified, and that the inventors possessed knowledge of the entire range and the points within the range.

Where used herein, the term “<100 MHz”, refers to any frequency, or range of frequencies, which is less than 100 MHz, and includes, for example, MHz frequencies of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, and 99 MHz.

Where used herein, the terms “frequency range <100 MHz” or “range of frequencies <100 MHz”, refer to any range of frequencies, which is less than 100 MHz, and includes, for example, frequency ranges bounded by any two distinct MHz frequencies selected from 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, and 99 MHz. Non-limiting examples of such ranges include: 1-50, 1-25, 1-10, 5-75, 5-50, 5-25, 10-50, 10-30, and so on.

In at least certain non-limiting embodiments, the excitation wavelengths of the apparatus and methods of the present disclosure have frequencies configured to span frequencies across a range between 1 to about 99 MHz. In at least one embodiment, the frequencies comprise a set of at least three different frequencies in a range between 1 to 99 MHz, the set comprising at least one frequency <50 MHz, and at least one frequency ≥50 MHz and <100 MHz, or the set comprising at least one frequency <51 MHz, and at least one frequency ≥51 MHz and <100 MHz. In another non-limiting embodiment, the set comprises at least one frequency <40 MHz, at least one frequency ≥40 MHz and <70 MHz, and at least one frequency ≥70 MHz and <100 MHz. In certain embodiments, the set may comprise 3, 4, 5, 6, 7, 8, 9, 10, or more different frequencies in a range between 1 to 99 MHz.

In other non-limiting embodiments, the frequencies comprise a set of at least four different frequencies in a range between 1 to 99 MHz, the set comprising at least two frequencies <50 MHz, and at least one frequency ≥50 MHz and <100 MHz.

In other non-limiting embodiments, the frequencies comprise a set of at least four different frequencies in a range between 1 to 99 MHz, the set comprising at least one frequency <50 MHz, and at least two frequencies ≥50 MHz and <100 MHz.

In other non-limiting embodiments, the frequencies comprise a set of at least five different frequencies in a range between 1 to 99 MHz, the set comprising at least two frequencies <50 MHz, and at least two frequencies ≥50 MHz and <100 MHz.

In other non-limiting embodiments, the frequencies comprise a set of three to five different frequencies in a range between 1 to 99 MHz, the set comprising at least one frequency <50 MHz, and at least one frequency ≥50 MHz and <100 MHz.

In other non-limiting embodiments, the frequencies comprise a set of three to five different frequencies in a range between 1 to 99 MHz, the set comprising at least one frequency <40 MHz, at least one frequency ≥40 MHz and <70 MHz, and at least one frequency ≥70 MHz and <100 MHz.

In one non-limiting embodiment, the set of frequencies is a set of three frequencies of about 33 MHz, about 66 MHz, and about 99 MHz.

In one non-limiting embodiment, the set of frequencies is a set of three frequencies of about 30 MHz, about 60 MHz, and about 90 MHz.

In one non-limiting embodiment, the set of frequencies is a set of three frequencies of about 20 MHz, about 55 MHz, and about 90 MHz.

In one non-limiting embodiment, the set of frequencies is a set of three frequencies of about 5 MHz, about 50 MHz, and about 95 MHz.

In one non-limiting embodiment, the set of frequencies is a set of four frequencies of about 20 MHz, about 46 MHz, about 72 MHz, and about 98 MHz.

In one non-limiting embodiment, the set of frequencies is a set of four frequencies of about 20 MHz, about 45 MHz, about 70 MHz, and about 95 MHz.

In one non-limiting embodiment, the set of frequencies is a set of four frequencies of about 24 MHz, about 48 MHz, about 72 MHz, and about 96 MHz.

In one non-limiting embodiment, the set of frequencies is a set of four frequencies of about 12 MHz, about 40 MHz, about 68 MHz, and about 96 MHz.

In one non-limiting embodiment, the set of frequencies is a set of five frequencies of about 10 MHz, about 32 MHz, about 54 MHz, about 76 MHz, and about 98 MHz.

In one non-limiting embodiment, the set of frequencies is a set of five frequencies of about 15 MHz, about 36 MHz, about 57 MHz, about 78 MHz, and about 99 MHz.

In one non-limiting embodiment, the set of frequencies is a set of five frequencies of about 20 MHz, about 38 MHz, about 56 MHz, about 74 MHz, and about 92 MHz.

In one non-limiting embodiment, the set of frequencies is a set of five frequencies of about 20 MHz, about 40 MHz, about 60 MHz, about 80 MHz, and about 98 MHz.

As used herein, the term “substantially” means that the subsequently described parameter, event, or circumstance completely occurs, or that the subsequently described parameter, event, or circumstance occurs to a great extent or degree. For example, the term “substantially” means that the subsequently described parameter, event, or circumstance occurs at least 90% of the time, or at least 91%, or at least 92%, or at least 93%, or at least 94%, or at least 95%, or at least 96%, or at least 97%, or at least 98%, or at least 99%, of the time, or means that the dimension or measurement is within at least 90%, or at least 91%, or at least 92%, or at least 93%, or at least 94%, or at least 95%, or at least 96%, or at least 97%, or at least 98%, or at least 99%, of the referenced dimension or measurement.

Circuitry, as used herein, may be analog and/or digital components, or one or more suitably programmed processor (e.g., microprocessor) and associated hardware and software, or hardwired logic. Also, “components” may perform one or more function. The term “component” may include hardware, such as a processor (e.g., microprocessor), and application specific integrated circuit (ASIC), field programmable gate array (FPGA), a combination of hardware and software, and/or the like. The term “processor” as used herein means a single processor or multiple processors working independently or together to collectively perform a task.

The terms “subject” and “patient” are used interchangeably herein and will be understood to refer to an organism to which the compositions of the present disclosure are applied and used, such as a vertebrate or more particularly to a warm-blooded animal, such as a mammal. Non-limiting examples of animals within the scope and meaning of this term include dogs, cats, rats, mice, guinea pigs, chinchillas, horses, goats, cattle, sheep, llamas, zoo animals, Old and New World monkeys, non-human primates, and humans.

“Treatment” refers to therapeutic treatments, such as for healing or restoration of damaged tissues. The term “treating” refers to administering the composition to a patient for therapeutic purposes, and may result in an amelioration of the condition or disease.

The terms “therapeutic composition” and “pharmaceutical composition” refer to an active agent composition, such as the hydrogel compositions described herein, that may be administered to a subject by any method known in the art or otherwise contemplated herein, wherein administration of the composition brings about a therapeutic effect as described elsewhere herein. In addition, certain compositions of the present disclosure may be designed to provide targeted, delayed, controlled, extended, and/or sustained release using formulation techniques which are well known in the art.

The term “effective amount” refers to an amount of an active agent which is sufficient to exhibit a detectable biochemical and/or therapeutic effect, for example without excessive adverse side effects (such as toxicity, irritation, and allergic response) commensurate with a reasonable benefit/risk ratio when used in the manner of the present disclosure. The effective amount for a patient will depend upon the type of patient, the patient's size and health, the nature and severity of the condition to be treated, the method of administration, the duration of treatment, the nature of concurrent therapy (if any), the specific formulations employed, and the like. Thus, it is not possible to specify an exact effective amount in advance. However, the effective amount for a given situation can be determined by a person of ordinary skill in the art using routine experimentation based on the information provided herein.

The term “ameliorate” means a detectable or measurable improvement in a subject's condition or symptom thereof. A detectable or measurable improvement includes a subjective or objective decrease, reduction, inhibition, suppression, limit or control in the occurrence, frequency, severity, progression, or duration of the condition, or an improvement in a symptom or an underlying cause or a consequence of the condition, or a reversal of the condition. A successful treatment outcome can lead to a “therapeutic effect,” or “benefit” of ameliorating, decreasing, reducing, inhibiting, suppressing, limiting, controlling, or preventing the occurrence, frequency, severity, progression, or duration of a condition, or consequences of the condition in a subject.

A decrease or reduction in worsening, such as stabilizing the condition, is also a successful treatment outcome. A therapeutic benefit therefore need not be complete ablation or reversal of the condition, or any one of, most of, or all of the adverse symptoms, complications, consequences, or underlying causes associated with the condition. Thus, a satisfactory endpoint may be achieved when there is an incremental improvement such as a partial decrease, reduction, inhibition, suppression, limit, control or prevention in the occurrence, frequency, severity, progression, or duration, or inhibition or reversal of the condition (e.g., stabilizing), over a short or long duration of time (e.g., seconds, minutes, hours).

Turning now to particular embodiments of the present disclosure, one non-limiting embodiment is directed to a frequency-domain (FD) FLIM implementation capable of simultaneous multi-wavelength excitation, simultaneous multispectral detection, and sub-nanosecond to nanosecond fluorescence lifetime estimation. Fluorescence excitation is implemented using frequency-modulated (FM) continuous wave (CW) diode lasers that are available in a selection of wavelengths spanning the UV-VI-NIR range (375-1064 nm). Laser digital pulse modulation was adopted to enable simultaneous frequency interrogation at the fundamental frequency and corresponding harmonics. Time-resolved fluorescence detection may be implemented using low-cost fixed-gain avalanche photodiodes; thus, enabling cost-effective fluorescence lifetime measurements at multiple emission spectral bands simultaneously.

Synchronized laser modulation and fluorescence signal digitization (250 MHz) is implemented using a common field-programmable gate array (FPGA). This synchronization reduces temporal jitter, which simplifies instrumentation, system calibration, and data processing. The use of an FPGA also allows implementing real-time processing of the fluorescence emission phase and modulation at three modulation frequencies and four spectral channels (processing rate matching the sampling rate of 250 MHz). Rigorous validation experiments have demonstrated the capabilities of this novel FD-FLIM implementation to accurately measure fluorescence lifetimes in the range of −0.4-12 ns using modulation frequencies below 100 MHz, eliminating the need of using high-bandwidth photodetectors and electronics. This novel technology is demonstrated, in one non-limiting embodiment, using an FD-FLIM endoscopy system for label-free metabolic imaging of oral lesions based on NADH (375 nm excitation, 484/37 nm emission) and FAD (445 nm excitation, 553/93 nm emission) autofluorescence imaging.

As noted above, in one non-limiting embodiment of the present disclosure, an FD-FLIM endoscopy system based on NADH (375 nm excitation, 484/37 nm emission) and FAD (445 nm excitation, 553/93 nm emission) autofluorescence imaging is used in a clinical setting for label-free metabolic imaging of malignant epithelial cells in oral lesions. Increased cellular metabolic activity, a hallmark of malignant epithelial cells, can be quantified by imaging the oral tissue autofluorescence originated from the metabolic cofactors NADH and FAD. In a non-limiting embodiment, we used a multispectral autofluorescence lifetime imaging (maFLIM) handheld device (hereinafter, the “maFLIM handheld probe”) probe to demonstrate clinical label-free metabolic imaging of oral epithelial cancer in patients presenting oral malignant lesions. The maFLIM handheld probe is capable of dual-wavelength excitation for more sensitive and specific metabolic imaging of the oral mucosa. The handheld probe enables simultaneous autofluorescence excitation at 375 nm (specific for NADH) and 445 nm (specific for FAD), and simultaneous multispectral time-resolved fluorescence measurement at four emission spectral channels: 405/40 nm (for elastin and collagen), 475/50 nm for NADH, 550/88 nm for FAD, and 647/57 nm for protoporphyrin IX. In a non-limiting embodiment, the handheld probe is 3D printed and comprises an enclosure (e.g., 8×15×5 mm³) and a rigid probe (e.g., diameter: 14 mm; length: 150 mm). The enclosure holds a pair of galvanometric mirrors for scanning, dichroic mirrors for combining the excitation beams and separating the fluorescence emission, and fiber collimators and mirrors for alignment. The rigid endoscope may comprise one or more achromatic lens (hereinafter, the “achromatic lenses”). In one embodiment, the rigid endoscope comprises three achromatic lenses (e.g., f=25 mm). While the rigid endoscope is described herein as comprising three of the achromatic lenses, it should be understood that the rigid endoscope may comprise a number of the achromatic lenses that is more or less than three.

A first pair of the achromatic lenses form a relay system, while the third of the achromatic lenses works as an objective lens, providing a field of view (FOV) of about 10 mm in diameter, and a lateral resolution of about 140 μm. The performance of the dual-wavelength excitation maFLIM handheld probe was assessed by imaging fluorescent dye standards with well characterized fluorescence lifetimes, and the oral mucosa of human subjects in oral health care settings. The results are described in further detail below. For use in label-free cancer detection (without using a contrast agent), the disclosed apparatus can be used to measure endogenous fluorescence biomarkers including but not limited to NADH, FAD, Collagen/elastin, Porphyrin IX, and Tryptophan. The technology can also be used with a fluorescence contrast agent is used (e.g., indocyanine green-ICG). The excitation wavelengths and emission spectral bands can be optimized based on the target fluorescent molecules of interest.

In various other embodiments, the methods and apparatus of the present disclosure can be used to target any exogenous or endogenous fluorophores within the analyzed sample, for example, to characterize the properties of the sample fluorescence, thereby gaining information about the sample composition and functionality (e.g., physiology in the case of a sample that is composed of living cells, tissues, or organs). The analyzed sample can be any material, object, or biomolecule that presents fluorescence properties (i.e., fluorescence can be excited from the sample). In certain embodiments the biological sample is an acellular biological material (e.g., viruses, viroids, prions). In certain embodiments the biological sample is a living organism, or portion of a living organism, or portion of a dead organism, including monerans (e.g., bacteria, blue green algae), protistans (e.g., protozoa and algae), fungi (e.g., yeasts and molds), plants (cells, tissues, organs), and animals (cells, tissues, organs), that presents fluorescence properties (fluorescence can be excited from the sample). To target specific fluorophores within the sample, specific excitation wavelengths, emission spectral channels, and digital modulation signals can be used see below), so that the fluorescence emission of the target fluorophores can be measured and characterized. The devices or instruments used in the methods of the present disclosures are not limited to endoscopic or handheld probe configurations, but can be designed to facilitate the fluorescence characterization of the sample of interest. For example, other embodiments can include but are not limited to any type of fluorescence spectrometer, any type of optical microscope, open top imaging configurations, histology slide scanners, optical point measurement probes, intraoperative imaging guiding tools, 2D imaging arrays, flow cytometers, microfluidic systems, stopped-flow spectrometer, wearable device-based spectrometer, among others.

FD-FLIM theory is well documented and understood. A fluorescent sample is first excited by a light source(s) modulated at specific frequency(s). The sample then emits fluorescence at the same frequency(s), but with a phase delay and reduced amplitude (modulation) relative to the excitation. The phase and modulation fluorescence lifetimes, τ_{ϕ} and τₘ, respectively, are calculated from the phase delay and modulation at each excitation frequency as shown below in Equations (1)-(3). The τ_{ϕ} and τₘ terms are also referred to as “apparent lifetimes” herein. Multi-exponential component lifetimes can be obtained from the phase delay and modulation using non-linear least squares analysis. The notation (λₑₘ, λₑₓ, y, x, f^{ex}) denotes emission band λₑₘ, excitation wavelength λₑₓ, image coordinates y, x (assuming a 2D image), and modulation frequency f^{ex} (Hz) at the given λₑₓ. The I_{em(λ}_{ₑₘ}_{,λ}_{ₑₓ}_{,y,x,f}_{^{ex}}₎, I_{ex(λ}_{ₑₓ}_{,y,x,f}_{^{ex}}₎, m_{(λ}_{ₑₘ}_{,λ}_{ₑₓ}_{,y,x,f}_{^{ex}}₎, and ϕ_{(λ}_{ₑₘ}_{,λ}_{ₑₓ}_{,y,x,f}_{^{ex}}₎ terms denote the fluorescence emission intensity, excitation intensity, modulation, and phase delay of the emission relative to the excitation, respectively.

$$\begin{matrix}{τ}_{ϕ ( {λ}_{em} , {λ}_{ex} , y , x , {f}^{ex} )} = \frac{1}{2 π {f}^{ex}} tan ( {ϕ}_{( {λ}_{em} , {λ}_{ex} , y , x , {f}^{ex} )} ) & ( 1 ) \\ {m}_{( {λ}_{em} , {λ}_{ex} , y , x , {f}^{ex} )} = \frac{{I}_{em ( {λ}_{em} , {λ}_{ex} , y , x , {f}^{ex} )} \div {I}_{em ( {λ}_{em} , {λ}_{ex} , y , x , 0 )}}{{I}_{ex ( {λ}_{ex} , y , x , {f}^{ex} )} \div {I}_{ex ( {λ}_{ex} , y , x , 0 )}} & ( 2 ) \\ {τ}_{m ( {λ}_{em} , {λ}_{ex} , y , x , {f}^{ex} )} = \sqrt{( {( {m}_{( {λ}_{em} , {λ}_{ex} , y , x , {f}^{ex} )} )}^{- 2} - 1 ) {( 2 π {f}^{ex} )}^{- 2}} & ( 3 )\end{matrix}$$

FD-FLIM system instrumentation limitations usually prohibit direct measurement of absolute values of ϕ and m required to calculate τ_{ϕ} and τₘ. Typically, a reference fluorophore with a known lifetime is used to calibrate the FD-FLIM system. By imaging a reference fluorophore with a known lifetime and decay kinetics (preferably mono-exponential for simplicity), correction factors (i.e., the instrument frequency response) can be computed to obtain absolute values of ϕ and m. These calibration procedures are specific to the particular implementation of the FD-FLIM system. The calibration procedures for our system are discussed in more detail in the “Data Processing—Theory” section below.

### Materials and Methods—Instrumentation

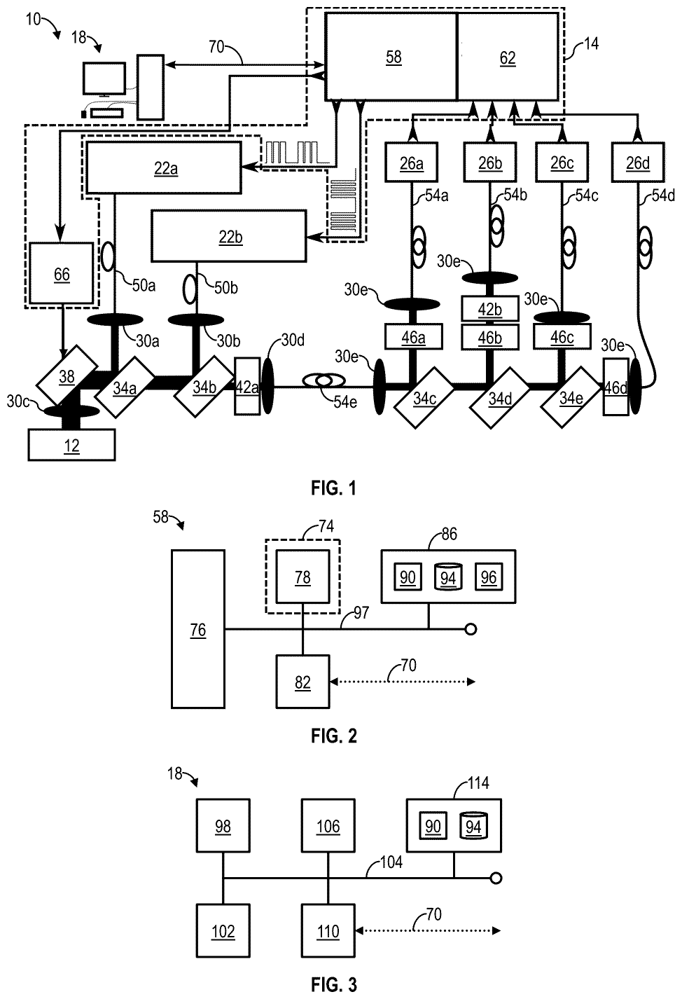

FIG. 1 is a diagrammatic view of a FD-FLIM system 10 (also referred to herein as the “FD-TRF system 10” or the “system 10”) constructed in accordance with the present disclosure. As described herein, the system 10 may be configured for simultaneous multiwavelength excitation of one or more compound 12 (hereinafter, the “sample 12”) and simultaneous multispectral time-resolved fluorescence measurement of an FFR of the sample 12. In some embodiments, the sample 12 is a sample of human epithelial tissue.

As shown in FIG. 1, the system 10 generally comprises an FD-FLIM engine 14 (indicated in FIG. 1 with a dotted line), a host computer 18, a plurality of excitation diode layers (e.g., a first excitation diode laser 22a (hereinafter, the “375 nm laser 22a”) and a second excitation diode laser 22b (hereinafter, the “445 nm laser 22b”) shown in FIG. 1) (collectively, the “diode lasers 22”), a plurality of Avalanche photodiodes (APDs) (e.g., a first APD (APD1) 26a, a second APD (APD2) 26b, a third APD (APD3) 26c, and a fourth APD (APD4) 26d shown in FIG. 1) (collectively, the “APDs 26”), a plurality of lenses (e.g., a first lens (L1) 30a, a second lens (L2) 30b, a third lens (L3) 30c, a fourth lens (L4) 30d, and a fifth lens (L5) 30e shown in FIG. 1) (collectively, the “lenses 30”), a plurality of dichroic mirrors (DMs) (e.g., a first DM (DM1) 34a, a second aDM (DM2) 34b, a third DM (DM3) 34c, a fourth DM (DM4) 34d, and a fifth DM (DM5) 34e shown in FIG. 1) (collectively, the “DMs 34”), a micro-electromechanical system (MEMS) mirror 38, a plurality of lowpass filters (LPFs) (e.g., a first LPF (LPF1) 42a and a second LPF (LPF2) 42b shown in FIG. 1) (collectively, the “LPFs 42”), and a plurality of bandpass filters (BPFs) (e.g., a first BPF (BPF1) 46a, a second BPF (BPF2) 46b, a third BPF (BPF3) 46c, and a fourth BPF (BPF4) 46d shown in FIG. 1).

The diode lasers 22 may be configured for simultaneous multispectral time-resolved fluorescence measurement of an FFR of a sample 12. The diode lasers 22 may be digital-pulse modulated diode lasers. Each of the diode lasers 22 may be connected to a particular one of the lenses 30 by a single-mode optical fiber (SMF) (e.g., a first SMF (SMF1) 50a and a second SMF (SMF2) 50b shown in FIG. 1) (collectively, the “SMFs 50”). More particularly, the 375 nm laser 22a may be connected to L1 30a by SMF1 50a, and the 445 nm laser 22b may be connected to L2 30b by SMF2 50b. In some embodiments, one or more of the SMFs 50 may have a mode field diameter (MFD) of 3.5 μm.

Each of the APDs 26 may be connected to a particular one of the lenses 30 by a multi-mode optical fiber (MMF) (e.g., a first MMF (MMF1) 54a, a second MMF (MMF2) 54b, a third MMF (MMF3) 54c, a fourth MMF (MMF4) 54d, and a fifth MMF (MMF5) 54e shown in FIG. 1) (collectively, the “MMFs 54”). More particularly, APD1 26a may be connected to L5 30e by MMF1 54a, APD2 26b may be connected to L5 30e by MMF2 54b, APD3 26c may be connected to L5 30e by the MMF3 54c, and APD4 26d may be connected to L5 30e by MMF4 54d. Further, L4 30d may be connected to L5 30e by MMF5 54e. In some embodiments, one or more of the MMFs 54 may have an MFD of 200 μm.

The diode lasers 22 and the APDs 26 may be configured to measure emission of NADH (375 nm excitation, 484/37 nm emission) and FAD (445 nm excitation, 553/93 nm emission). In some embodiments, the FD-FLIM engine 14 is disposed on a standard optics breadboard table with one-inch spaced holes. In some embodiments, one or more of the diode lasers 22 may be a continuous wave (CW) laser.

The FD-FLIM engine 14 generally includes a computing device 58, a digitizer 62, and a MEMS digital driver 66. In some embodiments, the FD-FLIM engine 14 may further comprise custom mounting hardware and/or other accessories (power supplies, etc.). For example, in some embodiments, the FD-FLIM engine 14 may further comprise a protective top plate (not shown) and 80 mm cooling fan (not shown). Each of the individual components of the FD-FLIM engine 14 are listed in Table 2 in the “Supplemental Information” section below.

The system 10 may be controlled via a host computer 18 communicating with the computing device 58 using a communication network 70. In some embodiments, the computing device 58 is a Zedboard. In some such embodiments, the computing device 58 contains a Xilinx ZYNQ-7000 series system on a chip (SoC). The computing device 58 generally comprises a processor space (PS) 74 (shown in FIG. 2) and a programmable logic (PL) 76 (also referred to as the “FPGA 76” herein) (shown in FIG. 2). The PS 74 may contain one or more processor 78 (hereinafter, the “on-board processor(s) 78”) (shown in FIG. 2). In some embodiments, one or more of the on-board processors 78 is an ARM CPU core. In some implement embodiments, the digitizer 62 is an FMC104 digitizer.

The communication network 70 may permit bi-directional communication of information and/or data between the system 10 and the host computer 18. The communication network 70 may interface with the system 10 and the host computer 18 in a variety of ways. For example, in some embodiments, the communication network 70 may interface by optical and/or electronic interfaces, and/or may use a plurality of network topographies and/or protocols including, but not limited to, Ethernet, TCP/IP, circuit switched path, combinations thereof, and/or the like. For example, in some embodiments, the communication network 70 may be implemented as the World Wide Web (or Internet), a local area network (LAN), a wide area network (WAN), a metropolitan network, a 4G network, a 5G network, a satellite network, a radio network, an optical network, a cable network, a public switch telephone network, an Ethernet network, combinations thereof, and/or the like, for example. Additionally, the communication network 70 may use a variety of network protocols to permit bi-directional interface and/or communication of data and/or information between the system 10 and the host computer 18.

Referring now to FIG. 2, shown therein is an exemplary embodiment of the computing device 58 shown in FIG. 1. The computing device 58 may comprise the PS 74 containing the on-board processor 78, the FPGA 76, one or more communication device 82 (hereinafter, the “on-board communication device 102”) capable of interfacing with the communication network 70, and one or more non-transitory processor-readable medium 86 (hereinafter, the “on-board memory 86”) storing processor-executable instructions and/or one or more software application 90 (hereinafter, the “software application 90”), one or more database 94 (hereinafter, the “database 94”), and one or more bitfile 96. The on-board processor 78, the on-board communication device 102, and the on-board memory 86 may be connected via a path 97 such as a databus that permits communication among the components of the computing device 58.

The on-board processor 78 may be capable of interfacing and/or communicating with the host computer 18 via the communication network 70 using the on-board communication device 102. For example, the on-board processor 78 may be capable of communicating via the communication network 70 by exchanging signals (e.g., analog, digital, optical, and/or the like) via one or more port (e.g., physical or virtual ports) using a network protocol to interface and/or communicate with the host computer 18.

In some embodiments, the computing device 58 may comprise one or more of the on-board processor 78 working together, or independently, to execute processor-executable code stored on the on-board memory 86. Each element of the computing device 58 may be partially or completely network-based or cloud-based, and may or may not be located in a single physical location. The on-board processor 78 may be implemented as a single processor or multiple processors working together, or independently, to execute the software application 90 as described herein. It is to be understood that in certain embodiments using more than one of the on-board processor 78, each may be located remotely from one another, located in the same location, or comprising a unitary multi-core processor. The on-board processor 78 may be capable of reading and/or executing processor-executable code and/or capable of creating, manipulating, retrieving, altering, and/or storing data structures into the on-board memory 86.

Exemplary embodiments of the on-board processor 78 may include, but are not limited to, a digital signal processor (DSP), a central processing unit (CPU), a field programmable gate array (FPGA), a graphics processing unit (GPU), a microprocessor, a multi-core processor, combinations, thereof, and/or the like, for example. The on-board processor 78 may be capable of communicating with the on-board memory 86 via the path 97.

In some embodiments, the on-board memory 86 may be located in the same physical location as the system 10, and/or one or more of the on-board memory 86 may be located remotely from the system 10. For example, the on-board memory 86 may be located remotely from the system 10 and communicate with the on-board processor 78 via the communication network 70. Additionally, when more than one of the on-board memory 86 is used, a first one of the on-board memory 86 may be located in the same physical location as the on-board processor 78, and an additional one of the on-board memory 86 may be located in a location physically remote from the on-board processor 78. Additionally, the on-board memory 86 may be implemented as a “cloud” non-transitory computer readable medium (i.e., one or more of the on-board memory 86 may be partially or completely based on or accessed using the communication network 70).

As described in more detail below, the software application 90 may, when executed, cause the on-board processor 78 to perform one or more of the methods described herein. Additionally, the on-board memory 86 may be implemented as a conventional non-transitory memory, such as for example, random access memory (RAM), CD-ROM, a hard drive, a solid-state drive, a flash drive, a memory card, a DVD-ROM, a disk, an optical drive, combinations thereof, and/or the like, for example. In some embodiments, the software application 90 may be stored as a data structure, such as the database 94 and/or a data table, for example, or in non-data structure format such as in a non-compiled text file.

The database 94 may be a relational database or a non-relational database. Examples of such databases comprise, DB2®, Microsoft® Access, Microsoft® SQL Server, Oracle®, MySQL, PostgreSQL, MongoDB, Apache Cassandra, and the like. It should be understood that these examples have been provided for the purposes of illustration only and should not be construed as limiting the presently disclosed inventive concepts. The database 94 may be centralized or distributed across multiple systems. The bitfile 96 may include processor-readable instructions that, when executed, cause the on-board processor 78 to configure the FPGA 76 in accordance with the present disclosure.

Referring now to FIG. 3, shown therein is an exemplary embodiment of the host computer 18 shown in FIG. 1. The host computer 18 may comprise one or more input device 98 (hereinafter, the “host input device 98”), one or more output device 102 (hereinafter, the “host output device 102”), one or more processor 106 (hereinafter, the “host processor 106”), one or more communication device 110 (hereinafter, the “host communication device 110”) capable of interfacing with the communication network 70, and one or more non-transitory processor-readable medium 114 (hereinafter, the “host memory 114”) storing the software application 90 and the database 94. The host input device 98, the host output device 102, the host processor 106, the host communication device 110, and the host memory 114 may be connected via a path 104 such as a databus that permits communication among the components of the host computer 18.

The host computer 18 may include, but is not limited to, implementation as a personal computer, a cellular telephone, a smart phone, a network-capable television set, a tablet, a laptop computer, a desktop computer, a network-capable handheld device, a server, a digital video recorder, a wearable network-capable device, and/or the like.

The host input device 98 may be capable of receiving information input from the user and/or the host processor 106 and transmitting such information to other components of the host computer 18 and/or the system 10. The host input device 98 may include, but is not limited to, implementation as a keyboard, touchscreen, mouse, trackball, microphone, fingerprint reader, infrared port, slide-out keyboard, flip-out keyboard, cell phone, PDA, remote control, fax machine, wearable communication device, network interface, combinations thereof, and/or the like, for example.

The host output device 102 may be capable of outputting information in a form perceivable by the user and/or the host processor 106. For example, implementations of the host output device 102 may include, but are not limited to, a computer monitor, a screen, a touchscreen, a speaker, a website, a television set, a smart phone, a PDA, a cell phone, a fax machine, a printer, a laptop computer, combinations thereof, and the like, for example.

It is to be understood that in some exemplary embodiments, the host input device 98 and the host output device 102 may be implemented as a single device, such as, for example, a touchscreen of a computer, a tablet, or a smartphone. It is to be further understood that, as used herein, the term “user” is not limited to a human being, and may comprise a computer, a server, a website, a processor, a network interface, a human, a user terminal, a virtual computer, combinations thereof, and/or the like, for example.

The host input device 98 may transmit data to the host processor 106 and may be located in the same physical location as the host processor 106, or located remotely and/or partially or completely network-based. The host output device 102 may transmit information from the host processor 106 to the user. The host output device 102 may be located with the host processor 106, or located remotely and/or partially or completely network-based.

As referenced above, the host processor 106 may be capable of interfacing and/or communicating with the system 10 via the communication network 70 using the host communication device 110. For example, the host processor 106 may be capable of communicating via the communication network 70 by exchanging signals (e.g., analog, digital, optical, and/or the like) via one or more ports (e.g., physical or virtual ports) using a network protocol to interface and/or communicate with the system 10.

In some embodiments, the host computer 18 may comprise one or more of the host processor 106 working together, or independently, to execute processor-executable code stored on the host memory 114. Each element of the host computer 18 may be partially or completely network-based or cloud-based, and may or may not be located in a single physical location. The host processor 106 may be implemented as a single processor or multiple processors working together, or independently, to execute the software application 90 as described herein. It is to be understood that in certain embodiments using more than one of the host processor 106, each may be located remotely from one another, located in the same location, or comprising a unitary multi-core processor. The host processor 106 may be capable of reading and/or executing processor-executable code and/or capable of creating, manipulating, retrieving, altering, and/or storing data structures into the host memory 114.

Exemplary implementations of the host processor 106 may include, but are not limited to, a digital signal processor (DSP), a central processing unit (CPU), a field programmable gate array (FPGA), a graphics processing unit (GPU), a microprocessor, a multi-core processor, combinations, thereof, and/or the like, for example. The host processor 106 may be capable of communicating with the host memory 114 via the path 104.

The host memory 114 may be implemented as a conventional non-transitory memory, such as for example, random access memory (RAM), CD-ROM, a hard drive, a solid-state drive, a flash drive, a memory card, a DVD-ROM, a disk, an optical drive, combinations thereof, and/or the like, for example.

In some embodiments, the host memory 114 may be located in the same physical location as the host computer 18, and/or one or more of the host memory 114 may be located remotely from the host computer 18. For example, the host memory 114 may be located remotely from the system 10 and communicate with the on-board processor 78 via the communication network 70. Additionally, when more than one of the host memory 114 is used, a first one of the host memory 114 may be located in the same physical location as the host processor 106, and an additional one of the host memory 114 may be located in a location physically remote from the host processor 106. Additionally, the host memory 114 may be implemented as a “cloud” non-transitory computer readable medium (i.e., one or more of the host memory 114 may be partially or completely based on or accessed using the communication network 70).

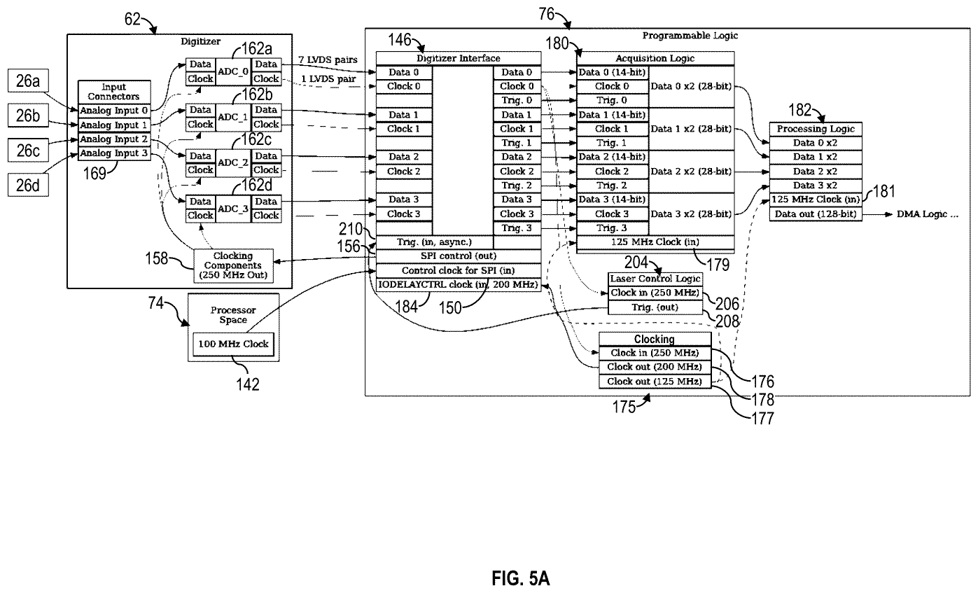

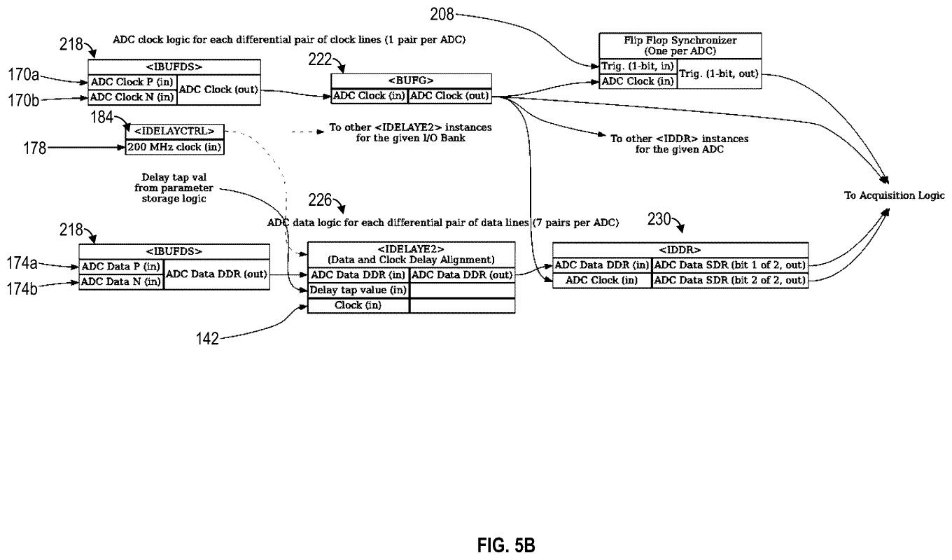

Referring back to FIG. 1, at power-up, a program for the PS 74 (i.e., the software application 90) and a bitfile for the FPGA 76 (i.e., the bitfile 96) are loaded automatically from an SD card (i.e., the on-board memory 86). After the power-up initialization, the FPGA 76 configures the digitizer's 62 clocking components to generate a 250 MHz clock signal and to distribute it to all four ADCs 162 (shown in FIG. 5A). The ADC0 162a clock signal is used as the clock signal for the laser digital modulation signal logic in the FPGA 76. The MEMS digital driver 66 is also initialized during this time by custom logic on the FPGA 76. Once initialization is complete, the host computer 18 sends a command via the communication network 70 to the PS 74 to begin an image acquisition. The PS 74 relays the start signal to the FPGA 76 to begin acquiring data. Once the FPGA 76 receives the start signal, the FPGA 76 simultaneously (a) generates SPI (serial programming interface) control signals to drive the MEMS mirror 38 to raster scan the sample 12, (b) generates two different digital modulation signals and outputs them to the diode lasers 22, and (c) begins acquiring and processing the digitized fluorescence emission signal. The 375 nm and 445 nm CW diode laser digital modulation signals are outputted from the JC1_P and JC2_P pins on the computing device 58, respectively. Each of the diode lasers 22 uses a fiber coupler (e.g., a SmartDock fiber coupler manufactured by Toptica Photonics) to couple its output into an SMF 50. The 375 nm laser's 22a output from SMF1 50a is collimated by L1 30a, and reflected onto the common excitation and emission path by longpass dichroic mirror DM1 34a. The 445 nm laser's 22b output from its SMF is collimated by L2 30b, and reflected by a notch DM2 34b onto the common excitation and emission path. L3 30c is used as an objective lens when raster scanning the sample 12. The fluorescence emission from the sample 12 is collected by L3 30c, transmitted through DM1 34a, DM2 34b, and LPF1 42a, coupled into MMF5 54e by L4 30d, collimated by L5 30e, and split into four emission channels by DM3-5 34c-e. BPF1-4 46a-d and LPF2 42b are used to further filter the fluorescence emission for each band. Each filtered emission band is then coupled to a 200 μm core diameter MMF 54 with L5 30e. The output of each MMF 54 is secured to an APD 26 with a custom adapter plate that holds the optical fiber in close proximity to the active area of the APD 26. The analog output of each APD 26 is connected in series to an amplifier (not shown), highpass filter (HPF) (not shown), and LPF 42. The output of each LPF 42 is connected to an analog input channel on the digitizer 62.

The analog output from each of the four APDs 26 is digitized with 14-bit resolution at 250 MS/s by the digitizer 62. Custom code for the FPGA 76 was written in VHDL for reading the digitized data from the digitizer 62 to the FPGA 76. An overview of the control logic if the digitizer 62 is located in “Digitizer Interface” section below.

The digitized data is processed first on the FPGA 76 and then on the host computer 18. The DFT is computed in the FPGA 76 as described in the “Data processing—FPGA” section below. The DFT output data is transferred to the DDR3 RAM and attached to the PS 74 via DMA (e.g., two pairs of Xilinx AXI4-Stream Data FIFO 2.0 and AXI Direct Memory Access 7.1 cores). Once the image is finished scanning, the DFT output data is transferred from the PS 74 DDR3 RAM to the host computer 18 via Ethernet using a custom bare metal c-program running on one processor core (e.g., the on-board processor 78) of the PS 74. Then, the system calibration and apparent lifetime calculations (τ_{ϕ} and τₘ) are performed on the host computer 18 as explained in the “Data Processing—Theory” section below. The computer operating system may be Linux Mint 20.3. All code for the FPGA 76 may be developed in Xilinx Vivado 2019.1, and custom code for the FPGA 76 may be written in VHDL. The PS 74 code may be written using the 1wIP (lightweight industrial protocol) echo server example in Vivado SDK 2019.1 as a starting point. All custom host computer codes responsible for image acquisition and processing may be written in Python3. The Python sockets module may be used on the host computer 18 to interface with the PS 74 over the communication network 70. All graphical user interface (GUI) codes may be written in Python3 using PyQt4 and PyQtGraph.

The digital modulation signals for both the 375 nm laser 22a and the 445 nm laser 22b are generated concurrently with data acquisition in the FPGA 76. Synchronization of the laser control logic and the ADC sampling clocks is required for operation of the FD-FLIM system 10. However, unlike FD-FLIM systems in the prior art, both the digitization and later control logic are located on the same FPGA 76. Synchronization may be accomplished by using the 250 MHz clock from the first ADC 162a (referred to as “ADC0” or “A10” herein) (shown in FIG. 5A) as the clock for the laser control logic as shown in the “Laser Control Logic” section below. Each diode laser's 22 digital modulation signal is generated in the FPGA 76 using two logically AND-ed counters as described in the prior art. The two frequencies for each diode laser 22 digital modulation signal will be written as f_{˜DC}^{ex} for the DC approximation frequency and f_{LT}^{ex} for the fundamental lifetime frequency.

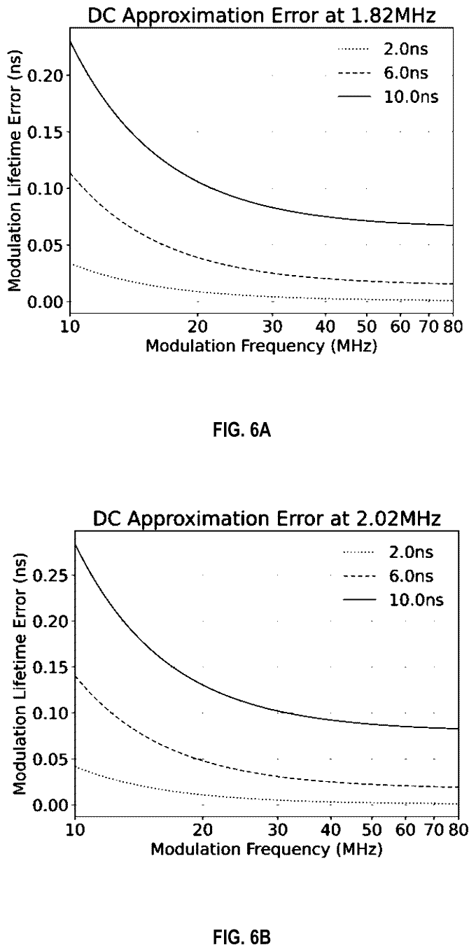

FIG. 6A shows a modulation lifetime τₘ error at f_{˜DC}³⁷⁵=1.82 MHz and FIG. 6B shows a modulation lifetime τₘ error at f_{˜DC}⁴⁴⁵=2.02 MHz. Error due to the DC approximation was less than approximately 0.1 ns for mono-exponential fluorophores with a 10 ns lifetime at each fundamental lifetime frequen

$${f}_{LT}^{375} = \frac{250}{9} = 27.78 MHz$$

and

$${f}_{LT}^{445} = \frac{250}{8} = 31.25 MHz .$$

Thus, the laser digital modulation frequencies for λₑₓ=375 nm were f_{˜DC}³⁷⁵=1.82 MHz and f_{LT}³⁷⁵ 27.78 MHz (see FIG. 6A), and the frequencies for λₑₓ=445 nm were f_{˜DC}⁴⁴⁵=2.02 MHz and f_{LT}⁴⁴⁵31.25 MHz (see FIG. 6B). See the “Modulation Frequency Selection” section below for more details on the frequency selection of digital modulation signals.

### Data Processing—Theory

FD-FLIM data is calibrated for system effects before applying Equations (1)-(3) to obtain the phase and modulation lifetimes. System effects include the presence of background noise, unequal power at each modulation frequency, and arbitrary phase shifts at each modulation frequency due to delays in the electronics and optical path lengths. The emission from each excitation source is processed independently. Processing methods for each excitation wavelength are similar to those described in the prior art. Data for system calibration is obtained by imaging reference fluorophores with known lifetimes. POPOP was used for lifetime calibration of λₑₓ=375 nm: λₑₘ=405/35 nm, λₑₘ=484/37 nm, and λₑₘ=553/93 nm data. A mono-exponential lifetime of 1.200 ns was assumed for POPOP. Fluorescein was used for lifetime calibration of λₑₓ=445 nm: λₑₘ=484/37 nm and

$${λ}_{em} = \frac{553}{93} nm .$$

A mono-exponential lifetime of 4.000 ns was assumed for fluorescein. Rose bengal was used for lifetime calibration of both excitation wavelengths in the λₑₘ=646/69 nm emission channel. A mono-exponential lifetime of 0.076 ns was assumed for rose bengal. The three fluorescence references (POPOP, fluorescein, rose bengal) are imaged at the beginning of each imaging session, and the reference data is used for system intensity and lifetime calibrations of all FD-FLIM images acquired during the particular imaging session. Fluorophores are detailed in the “Standard Fluorophores” section below.

First the fluorescence emission is digitized by the digitizer 62 and sampled in the FPGA 76 acquisition logic: d_{(λ}_{ₑₘ}_{,y,x,t)}^{measured}. Then the DFT is calculated in the FPGA 76 at the prescribed frequencies, giving D_{(λ}_{ₑₘ}_{,y,x,f)}^{measured}. After the DFT is calculated, another dimension is introduced for the excitation wavelength λₑₓ, and an additional label is added to the frequency f to indicate the excitation wavelength fₑₓ where ex is either 375 nm or 445 nm. The data is then rewritten as D_{(λ}_{ₑₘ}_{,λ}_{ₑₓ}_{, y, x, f}_{^{ex}}₎^{measured}. Then the complex frequency domain data (one real and imaginary 64-bit number per frequency) is transferred from the FPGA 76 to the host computer 18.

Once D_{(λ}_{ₑₘ}_{,λ}_{ₑₓ}_{, y, x, f}_{^{ex}}₎^{measured} is transferred to the host computer 18, system calibration is performed (detailed in the “Data Processing—Theory” section below). The final calibrated data consists of normalized intensities and apparent phase and modulation lifetimes. Î_{(λ}_{ₑₘ}_{, λ}_{ₑₓ}_{, y, x)}^{C-inter} is the inter- or between-emission-channel intensity. For example, IC_{405, 375, 7, 4}^{C-inter}=0.5 indicates that half of the fluorescence from 375 nm excitation was detected in emission channel 405 nm at pixel location (7,4) in the given image. Î_{(λ}_{ₑₘ}_{, λ}_{ₑₓ}_{, y, x)}^{C-intra} is the intra- or within-emission-channel intensity. An intra-intensity of Î_{(484, 375, 10, 50)}^{C-intra}=0.7 indicates that 70% of the fluorescence intensity in channel 484 nm was from 375 nm excitation at pixel location (10,50) in the given image.

$$\begin{matrix}{\hat{I}}_{( {λ}_{em} , {λ}_{ex} , y , x )}^{C - inter} & ( 4 ) \\ {\hat{I}}_{( {λ}_{em} , {λ}_{ex} , y , x )}^{C - intra} & ( 5 )\end{matrix}$$

The same terms introduced above are used to denote the apparent phase and modulation lifetimes. The LT subscript is added to the frequency term f_{LT}^{ex} to indicate that this is a modulation frequency used for lifetimes. Now the ϕ(λₑₘ, λₑₓ, y, x, f_{LT}^{ex}) and m(λₑₘ, λₑₓ, y, x, f_{LT}^{ex}) terms denote the phase and modulation after system calibration.

$$\begin{matrix}{τ}_{ϕ ( {λ}_{em} , {λ}_{e} , y , x , {f}_{LT}^{375} )} = \frac{1}{2 π {f}_{LT}^{ex}} tan ( {ϕ}_{( {λ}_{em} , {λ}_{ex} , y , x , {f}_{LT}^{ex} )} ) & ( 6 ) \\ {τ}_{m ( {λ}_{em} , {λ}_{ex} , y , x , {f}_{LT}^{ex} )} = \sqrt{( {( {m}_{( {λ}_{em} , {λ}_{ex} , y , x , {f}_{LT}^{ex} )} )}^{- 2} - 1 ) {( 2 π {f}_{LT}^{ex} )}^{- 2}} & ( 7 )\end{matrix}$$

Finally, the τ̅ term denotes the average lifetime from fitting a bi-exponential model to the calibrated FD-FLIM data as explained in the “In vivo Human Finger and Human Oral Mucosa” section below. The τ̅ term is introduced to better compare the in vivo lifetimes with other studies.

$$\overline{τ} ( {λ}_{em} , {λ}_{ex} , y , x , {f}_{LT}^{ex} ) \qquad ( 8 )$$

### Data Processing—FPGA

FPGA 76 processing was developed to allow for real-time imaging, to lower equipment costs, and to facilitate adapting the FD-FLIM system 10 to a clinical setting. The four-channel 250 MS/s digitized fluorescence emission from the digitizer 62 has a throughput of 1.862 GiB/s, assuming each 14-bit number was transferred to a 16-bit number from the FPGA 76 to the host computer 18 in a typical imaging system setup without processing by the FPGA 76. This relatively large data throughput would require an interface such as PCIe (peripheral component interconnect express) for real-time performance. By performing the DFT at the modulation frequencies of interest on the FPGA 76, the data throughput is reduced from 1.862 GiB/s to roughly 9 MiB/s before transferring the data to the host computer 18. This FD-FLIM system calibration, intensity, apparent phase lifetime, and apparent modulation lifetime calculations are then performed on the host computer 18.

The DFT algorithm implemented on the FPGA 76 is detailed in the “Supplemental Information” section below. The DFT may be implemented in VHDL with core math operations implemented with free Xilinx IP cores that are included in Xilinx Vivado 2019.1. The resource usage summary of the overall design and various components is listed in the “Supplemental Information” section below. The DFT is calculated in two decimated sums as shown below in Equation (9). N is the maximum number of time points in the DFT (65536), and M is the actual number of time points in the DFT (M=20000 for a pixel frequency of 12.5 kHz). The z[n] and Z[k] terms are shorthand for d_{(λ}_{ₑₘ}_{, y, x, n)} and D_{(λ}_{ₑₘ}_{,y, x, k)}^{measured}, respectively, as the DFT calculations are identical for all y and x, with different k vales for various λₑₘ and λₑₓ combinations. Index terms n and k are substituted for their time and frequency counterparts, t and f, respectively.

$$N = 65536 \\ M \leq N \\ {f}_{s} = 250 MHz \\ f = k \cdot {f}_{s} \div N \\ t = n \cdot {f}_{s} \\ 0 \leq k < N \div 2 - 1 \\ j = \sqrt{- 1} \\ z [ n ] ≡ {d}_{( {λ}_{em} , y , x , n )}^{measured} \\ Z [ k ] ≡ {D}_{( {λ}_{em} , y , x , k )}^{measured} \\ {Z}_{n - 1} [ k ] = {\sum }_{n = 0 , 2 , 4 , …}^{M - 2} z [ n ] {e}^{- 2 π jkn / N} \\ {Z}_{n} [ k ] = {\sum }_{n = 1 , 3 , 5 , …}^{M - 1} z [ n ] {e}^{- 2 π jkn / N} \\ Z [ k ] = {Z}_{n - 1} [ k ] + {Z}_{n} [ k ] \qquad ( 9 )$$

### Alternating Mode

The fluorescence emission from each excitation consists of frequency components at the DC approximation frequency f_{≈DC}^{ex}, the lifetime frequency f_{LT}^{ex}, DC approximation frequency harmonics (2f_{≈DC}^{ex}, 3f_{≈DC}^{ex}, etc.), lifetime frequency harmonics (2_{LT}^{ex}, 3_{LT}^{ex}, etc.), and mixed harmonics (f_{LT}^{ex}±f_{≈DC}^{ex}, f_{LT}^{ex}±2f_{≈DC}^{ex}, . . . , 2f_{LT}^{ex}±f_{≈DC}^{ex}, 2f_{LT}^{ex}±2f_{≈DC}^{ex}, . . . , 3f_{LT}^{ex}±f_{≈DC}^{ex}, 3f_{LT}^{ex}±2f_{≈DC}^{ex}, etc.). The fluorescence emission signal also contains noise across the entire frequency spectrum due to the discrete nature of light detection. Although separate non-overlapping digital modulation frequencies are used for each diode laser 22, the detection noise from one λₑₓ had a noticeable effect on the signal from the other λₑₓ within the same emission channel λₑₘ. Alternating mode was implemented to provide full noise isolation within a given emission channel between the omission from each λₑₓ at the expense of halving the acquisition time for the given λₑₓ. Alternating mode was implemented by making λₑₓ=375 nm active for the first half and λₑₓ=445 nm active for the last half of the dwell time of each spatial pixel, respectively. The DFT logic was modified to include enable/disable logic for alternating mode. When alternating mode is active, zeroes are multiplexed in place of the digitized fluorescence emission to effectively zero pad the DFT logic for the inactive excitation wavelength. Similarly in the laser control logic, the inactive excitation wavelength's laser control signal is driven low to disable it during the inactive half of the spatial pixel. Alternating mode was used for all data presented in the present disclosure.

### Excitation Light Exposure and MPE

The excitation light exposure of the system 10 was calculated in order to ensure that in vivo images of skin could be acquired without tissue damage. The maximum permissible exposure (MPE) for skin was calculated according to the guidelines for the American National Standards Institute (ANSI) for Safe Use of Lasers. The thermal MPE over a limiting aperture with a diameter of 3.5 mm was the limiting exposure case. The MPE for each excitation source is

$${MPE}_{375 nm} = 0.56 \cdot {( {T}_{3.5 ϕ} )}^{0.25} \frac{J}{{cm}^{2}} = 0.63 \frac{J}{{cm}^{2}} and 1.1 \cdot {( {T}_{3 , 5 ϕ} )}^{0.25} \frac{J}{{cm}^{2}} = 1.24 \frac{J}{{cm}^{2}} .$$

The worst-case exposure of the system 10 was calculated assuming all pixels were acquired in a 3.5 mm diameter aperture; thus, T_{3.5ϕ} corresponds to the exposure time for the 3.5 mm aperture. All images acquired in the present disclosure utilized the same parameters unless otherwise specified: alternating mode, 12.5 kHz pixel rate, 4 mm by 3 mm field of view, and a raster scanned image size of 160 by 160 pixels (plus 80 fly back pixels) for a total imaging time of 3.072 s. The average power at the sample position, including the digital modulation signals and alternating mode, was 9 mW for λₑₓ=375 nm and 14 mW for λₑₓ=445 nm. The digital modulation signals for both diode lasers 22 were disabled during flyback by the FPGA 76 logic to limit excess exposure to the sample 12 being imaged. The number of pixels and 3.5 mm aperture was:

$${N}_{3.5 ϕ} = {π [ 3.5 mm / 2 ]}^{2} / [ \frac{4 mm}{160} \cdot \frac{3 mm}{160} ] = 20525.$$

The exposure time for the 3.5 mm aperture was T_{3.5ϕ}=N_{3.5ϕ}/12.5 kHz=1.642 s. The exposures for each excitation wavelength were

$${Exp}_{375} = 9 mW \cdot {T}_{3.5 ϕ} / [ {π ( 3.5 mm / 2 )}^{2} ] / 1 e 4 \frac{J}{{cm}^{2}} = 0.154 \frac{J}{{cm}^{2}}$$

and

$${Exp}_{445} = 14 mW \cdot {T}_{3.5 ϕ} / [ {π ( 3.5 mm / 2 )}^{2} ] / 1 e 4 \frac{J}{{cm}^{2}} = 0.239 \frac{J}{{cm}^{2}} .$$

The worst-case exposure of the system 10 was less than the MPE for both excitation sources in the worst-case exposure scenario:

$${Exp}_{375} = 0.154 \frac{J}{{cm}^{2}} < 0.63 \frac{J}{{cm}^{2}} and {Exp}_{445} = 0.239 \frac{J}{{cm}^{2}} < 1.24 \frac{J}{{cm}^{2}} .$$

The actual exposure of the system 10 was lower than the worst-case, as the field of view was larger than the 3.5 mm limiting aperture, the imaging time was longer, and the diode lasers 22 were disabled during the 50% flyback portion of the raster scan.

### Fluorescent Sample Preparation and FD-FLIM Imaging

### Standard Fluorophores

The following fluorophores were imaged to evaluate the fluorescence lifetime measurement accuracy of the FD-FLIM system 10: 1 μM 9CA (9-Anthracenecarbonitrile, Sigma Aldrich 152765) in ethanol (E7023, Sigma Aldrich), 1 μM ANT (anthracene, Sigma Aldrich A3885) in ethanol, 0.1 μM Coumarin 6 (C6, Sigma Aldrich 546283) in ethanol, 1 μM DPA (9,10-Diphenylanthracene, Sigma Aldrich D205001) in ethanol, 0.1 μM FAD (flavin adenine dinucleotide, Sigma Aldrich F6625) in PBS (deionized (DI) water mixed with phosphate buffered saline P5368, Sigma Aldrich), 1 μM FLU (Fluorescein, 46960, Sigma Aldrich) in PBS, 0.1 μM FLU DI water (Flurescein, 46960, Sigma Aldrich in DI water), 100 μM POPOP ([1,4-Bis(5-phenyl-2-oxazolyl)benzene], Sigma Aldrich P3754) in ethanol, 0.1 μM Rub (Rubrene, Sigma Aldrich 554073) in methanol, and 100 μM RoseB (rose bengal, Sigma Aldrich 330000) in PBS. Fluorophore solutions were not degassed. Concentrations for all fluorophores were diluted from stock concentrations to avoid saturating the APDs 26 and the digitizer 62 after the APD gains were set. The gain for each APD 26 was set by acquiring data in vivo from a human finger and gradually increasing the gain until the analog output of the APD 26 saturated the analog input of the digitizer 62. The same APD gains were used to image all reference fluorophores and in vivo samples 12 in the present disclosure. Literature lifetimes for the aforementioned fluorophores are listed in Table 1. Fluorophores were placed in quartz cuvettes (e.g., R-3010-T manufactured by Spectrocell) for imaging. Overhead room lights in the lab remained on throughout imaging to mimic ambient light conditions in a clinical setting. Cuvettes were positioned so that the field of view also contained an empty region from outside the cuvette to be used for background subtraction. One set of reference fluorophore data (POPOP in ethanol, fluorescein in PBS, and rose bengal in PBS) was acquired at the start of the imaging session and used to calibrate all images acquired in the imaging session, as described previously in the “Data Processing—Theory” section above.

### In Vivo Human Finger and Human Oral Mucosa

The FD-FLIM system's 10 ability to image autofluorescence of biological tissue was demonstrated by imaging in vivo human finger skin and human oral mucosa. First, the reference fluorophores (POPOP in ethanol, fluorescein in PBS, and rose bengal in PBS) were imaged as described previously in the “Data Processing—Theory” section above. Then, in vivo images were acquired from the tip of a human index finger and the apex of a human tongue. One image without anything at the sample position (blank image) was acquired after each in vivo image for background subtraction. Overhead room lights in the lab remained on throughout imaging to mimic ambient light conditions in a clinical setting. Fluorescence average lifetimes were measured for the in vivo data from a dual-exponential decay function fitted to the magnitude and phase frequency responses measured at the three used modulation frequencies.

The apparent phase and modulation lifetime values were in agreement with the values reported in the prior art. For NADH, the mean values of τ_{ϕ} range from 0.42-0.48 ns, close to the expected lifetime of 0.44 ns. The values of τₘ are overestimated due to the short lifetime of NADH relative to the modulation frequencies used in the system 10 (limited to <100 MHz) and how τₘ is calculated. In such cases the distribution of modulation m values will be centered closest to 1, but with some values being >1 and <1 depending on the signal quality. Values of m>1 were omitted because they resulted in complex values for τₘ when applying Equation (3). This omission lowered the mean value of m and increased the mean value of τₘ when results were reported in Table 1. More accurate sub-nanosecond lifetime estimations are possible if higher modulation frequencies are used; however, the bandwidth of the system 10 was purposely restricted to 100 MHz in order to use cost-effective detectors and sampling electronics, as discussed in the “DFT Module Implementation” section below. C6 lifetimes are slightly longer than the expected 2.4 ns, with τₘ being the most overestimated. As expected, we observed mono-exponential behavior with similar τₘ and τ_{ϕ} values across all modulation frequencies for C6. The τₘ and τ_{ϕ} lifetime values for FAD are close to the expected literature value of 2.70 ns. Since FAD presents multiple exponential components, we observed as expected τₘ>τ^{ϕ} for each (λₑₘ, λₑₓ, f_{LT}^{ex}). Furthermore, the apparent lifetimes of FAD at λₑₓ=375 nm were similar to the prior art, although the emission channels were not identical. The mean values of τₘ and τ_{ϕ} for FLU in DI water range from 3.20 ns to 3.70 ns, which is shorter than the ≈4 ns lifetime of FLU in PBS that was used for calibration. This is expected as the pH of DI water is lower than PBS (although the pH of the solutions were not measured). ANT, DPA, and 9CA lifetime values were close to the expected literature values. The RUB τₘ and τ_{ϕ} lifetimes are approximately 2-3 ns shorter than the literature degassed lifetime of 9.9 ns. Shorter lifetimes were expected for RUB, as the solution of RUB was not degassed before imaging.

Overall, these results demonstrated the following capabilities of this FD-FLIM system 10. First, it was possible to excite fluorophores with significantly different absorption spectra. Second, it was possible to image both fluorescence intensity and lifetime at multiple emission spectral bands simultaneously. Third, it was possible to measure fluorescence lifetimes within a broad range of values (0.4-12 ns) using only three modulation frequencies spanning a narrow bandwidth of 100 MHz.

### Results and Discussion

### Reference Fluorophores

The reference fluorophores data acquired with the FD-FLIM system 10 is summarized in Table 1. The reported mean calibrated inter-channel (Î^{C-inter}) and intra-channel (Î^{C-intra}) normalized intensities were in agreement with the excitation and emission spectral characteristics of each fluorophore. NADH was excited only at 375 nm, with the strongest emission in the 484 nm band and significant emission also in the 553 nm band. C6 was more strongly excited at 445 nm, with strong emission in both the 484 nm and 553 nm bands. FAD and FLU were excited at both 375 nm and 445 nm, with dominant emission (70-75%) in the 554 nm band. ANT was only excited at 375 nm, with dominant emission (90%) in the 405 nm band. DPA was excited only at 375 nm, with the strongest emission in the 405 nm band and significant emission also in the 484 nm band. RUB was more strongly excited at 445 nm, with the strongest emission in the 553 nm band and significant emission also in the 646 nm band. 9CA was only excited at 375 nm, with the strongest emission in the 484 nm band and significant emission also in the 405 nm and 553 nm bands.

The apparent phase and modulation lifetime values were in agreement with the values reported in the prior art. For NADH, the mean values of τ_{ϕ} range from 0.42-0.48 ns, close to the expected lifetime of 0.44 ns. The values of τₘ are overestimated due to the short lifetime of NADH relative to the modulation frequencies used in the system 10 (limited to <100 MHz) and how τₘ is calculated. In such cases the distribution of modulation m values will be centered close to 1, but with some values being >1 and <1 depending on the signal quality. Values of m >1 were omitted because they resulted in complex values for τₘ when applying Equation (3). This omission lowered the mean value of m and increased the mean value of τₘ when results were reported in Table 1. More accurate sub-nanosecond lifetime estimations are possible if higher modulation frequencies are used; however, the bandwidth of the system 10 was purposely restricted to 100 MHz in order to use cost-effective detectors and sampling electronics, as discussed in the “DFT Module Implementation” section below. C6 lifetimes are slightly longer than the expected 2.4 ns, with τₘ being the most overestimated. As expected, we observed mono-exponential behavior with similar τ_{ϕ} and τₘ values across all modulation frequencies for C6. The T and τₘ lifetime values for FAD are close to the expected literature value of 2.70 ns. Since FAD presents multiple exponential components, we observed as expected τₘ>τ_{ϕ} for each (λₑₘ,λₑₓ, f_{LT}^{ex}). Furthermore, the apparent lifetimes of FAD at λₑₓ 375 nm were similar to the prior art, although the emission channels were not identical. The mean values of τ_{ϕ} and τₘ for FLU in DI water ranged from 3.20 ns to 3.70 ns which is shorter than the ≈4 ns lifetime of FLU in PBS that was used for calibration. This is expected as the pH of DI water is lower than PBS (although the pH of the solutions was not measured). ANT, DPA, and 9CA lifetime values were close to the expected literature values. The RUB τₘ and τ_{ϕ} lifetimes are approximately 2-3 ns shorter than the literature degassed lifetime of 9.9 ns. Shorter lifetimes were expected for RUB, as the solution of RUB was not degassed before imaging.

Overall, these results demonstrated the following capabilities of this FD-FLIM system 10. First, it was possible to excite fluorophores with significantly different absorption spectra. Second, it was possible to image both fluorescence intensity and lifetime at multiple emission spectral bands simultaneously. Third, it was possible to measure fluorescence lifetimes within a broad range of values (0.4-12 ns) using only three modulation frequencies spanning a narrow bandwidth of 100 MHz.

TABLE 1
Fluorophore normalized intensities and lifetimes imaged with the FD-FLIM system*

| | λₑₓ:λₑₘ | inter::intra | τ̅ | τ | f_{LT}^{ex} | 2 f_{LT}^{ex} | 3 f_{LT}^{ex} |
|---|---|---|---|---|---|---|---|
| NADH | 375:405 | 5(0)::100(0) | 0.47(0.10) | ϕ | 0.47(0.18) | 0.44(0.12) | 0.42(0.13) |
| | | | | m | | 0.80(0.32) | 0.73(0.30) |
| | 375:484 | 55(0)::100(0) | 0.46(0.09) | ϕ | 0.48(0.05) | 0.45(0.03) | 0.45(0.03) |
| | | | | m | 0.76(0.28) | 0.53(0.15) | 0.54(0.10) |
| | 375:553 | 34(0)::100(0) | 0.44(0.09) | ϕ | 0.44(0.05) | 0.43(0.03) | 0.43(0.03) |
| | | | | m | 0.84(0.28) | 0.50(0.15) | 0.48(0.11) |
| | 375:646 | 5(0)::99(0) | 0.52(0.10) | ϕ | 0.52(0.19) | 0.50(0.12) | 0.48(0.13) |
| | | | | m | | 0.81(0.33) | 0.73(0.29) |
| C6 | 375:484 | 43(2)::7(1) | 2.34(0.12) | m | | 2.39(0.48) | |
| | 445:484 | 44(0)::93(1) | 2.62(0.10) | ϕ | 2.50(0.05) | 2.46(0.05) | 2.58(0.09) |
| | | | | m | 2.96(0.08) | 2.58(0.05) | 2.59(0.06) |
| | 375:553 | 51(4)::7(1) | 2.38(0.10) | m | 2.30(0.56) | 2.37(0.28) | 2.40(0.33) |
| | 445:553 | 53(0)::93(1) | 3.03(0.09) | ϕ | 2.49(0.03) | 2.48(0.04) | 2.56(0.06) |
| | | | | m | 3.05(0.05) | 2.60(0.03) | 2.58(0.04) |
| | 445:646 | 3(0)::93(1) | 2.64(0.15) | ϕ | 2.56(0.22) | 2.58(0.27) | |
| | | | | m | 2.53(0.43) | 2.59(0.27) | 2.63(0.40) |
| FAD | 375:484 | 11(2)::49(5) | 2.57(0.12) | m | | 2.70(0.29) | 2.61(0.36) |
| | 445:484 | 10(0)::51(5) | 3.02(0.15) | ϕ | 2.61(0.14) | 2.42(0.15) | 2.39(0.29) |
| | | | | m | 3.28(0.21) | 2.84(0.16) | 2.77(0.21) |
| | 375:553 | 74(6)::48(5) | 2.72(0.09) | m | 3.07(0.74) | 2.81(0.13) | 2.70(0.08) |
| | 445:553 | 75(0)::52(5) | 3.25(0.08) | ϕ | 2.57(0.04) | 2.38(0.04) | 2.31(0.06) |
| | | | | m | 3.46(0.06) | 2.88(0.04) | 2.79(0.05) |
| | 375:646 | 15(1)::48(5) | 2.80(0.11) | m | 3.02(0.33) | 2.85(0.21) | 2.81(0.27) |
| | 445:646 | 15(0)::52(5) | 2.69(0.10) | ϕ | 2.64(0.10) | 2.47(0.11) | 2.35(0.20) |
| | | | | m | 3.01(0.17) | 2.83(0.11) | 2.75(0.15) |
| FLU di | 375:484 | 20(1)::21(2) | 3.25(0.14) | m | | 3.33(0.77) | |
| | 405:484 | 20(0)::79(2) | 3.53(0.08) | ϕ | 3.50(0.15) | 3.49(0.23) | 3.70(0.60) |
| | | | | m | 3.59(0.20) | 3.49(0.16) | 3.52(0.26) |
| | 375:553 | 68(5)::22(2) | 3.29(0.09) | m | 3.32(0.54) | 3.30(0.20) | 3.29(0.28) |
| | 405:553 | 70(0)::78(2) | 3.57(0.08) | ϕ | 3.45(0.06) | 3.41(0.09) | 3.46(0.19) |
| | | | | m | 3.64(0.08) | 3.49(0.06) | 3.51(0.09) |
| | 445:646 | 10(0)::77(2) | 3.52(0.23) | ϕ | 3.40(0.20) | 3.42(0.32) | 3.54(0.88) |
| | | | | m | 3.20(0.29) | 3.37(0.23) | 3.39(0.37) |
| ANT | 375:405 | 90(1)::100(0) | 4.16(0.06) | ϕ | 4.17(0.06) | 4.16(0.10) | 4.21(0.20) |
| | | | | m | 4.13(0.08) | 4.14(0.07) | 4.14(0.10) |
| | 375:484 | 9(0)::99(0) | 4.13(0.08) | ϕ | 4.17(0.27) | 4.16(0.50) | |
| | | | | m | 4.00(0.36) | 4.10(0.33) | 4.18(0.56) |
| DPA | 375:405 | 67(0)::100(0) | 6.13(0.03) | ϕ | 6.01(0.07) | 5.91(0.16) | 5.91(0.41) |
| | | | | m | 6.12(0.06) | 6.06(0.08) | 6.06(0.14) |
| | 375:484 | 30(0)::100(0) | 6.04(0.05) | ϕ | 6.06(0.16) | 5.98(0.37) | 6.16(1.05) |
| | | | | m | 6.02(0.14) | 6.04(0.18) | 6.06(0.30) |
| | 375:553 | 3(0)::98(0) | 6.02(0.08) | ϕ | 6.05(0.44) | 6.12(1.17) | |
| | | | | m | 5.97(0.40) | 5.99(0.51) | 6.15(0.99) |
| RUB | 375:553 | 68(5)::14(1) | 6.37(0.23) | m | 7.14(0.75) | 6.44(0.96) | |
| | 445:553 | 74(0)::86(1) | 7.91(0.05) | ϕ | 7.75(0.27) | 7.56(0.81) | |
| | | | | m | 7.79(0.17) | 7.87(0.28) | 7.88(0.52) |
| | 445:646 | 25(0)::85(1) | 9.17(0.08) | ϕ | 8.04(0.62) | | |
| | | | | m | 7.52(0.37) | 7.86(0.64) | 7.91(1.37) |
| 9CA | 375:405 | 24(0)::100(0) | 11.81(0.08) | ϕ | 11.18(0.40) | 9.97(1.23) | |
| | | | | m | 11.77(0.21) | 11.64(0.39) | 11.66(0.78) |
| | 375:484 | 61(0)::100(0) | 11.88(0.05) | ϕ | 11.48(0.36) | 11.12(1.26) | |
| | | | | m | 12.03(0.18) | 11.87(0.33) | 11.81(0.62) |
| | 375:553 | 15(0)::100(0) | 11.87(0.06) | ϕ | 11.49(0.60) | 11.29(2.28) | |
| | | | | m | 11.90(0.30) | 11.72(0.55) | 11.71(1.05) |

*Fluorophore normalized intensities and lifetimes imaged with the FD-FLIM system 10. The left column with the fluorophore names, λₑₓ:λₑₘ lists the excitation and center emission wavelengths, Î^{C-inter}::Î^{C-intra} lists the mean and standard deviation in percent (0-100%) rounded to the nearest integer of the calibrated inter-channel and intra-channel normalized intensities, the τ̅ column contains the average lifetimes, the τ column indicates if the entries in the remaining right columns are the apparent phase or modulation lifetimes (τ_{ϕ} or τₘ), the remaining f_{LT}^{ex} columns list the mean and standard deviation of the apparent phase or modulation lifetimes (nanoseconds). For intensities and lifetimes, the values are listed as mean (standard deviation). Fluorophore solutions were not degassed. Lifetime entries in the table were omitted if the standard deviation was larger than 25% of the mean, except in cases where the standard deviation was <0.5 ns. Fluorescence average lifetimes, τ̅, were measured from a dual-exponential decay function fitted to the magnitude and phase frequency responses measured at the three used modulation frequencies.

In vivo Human Finger and Human Oral Mucosa

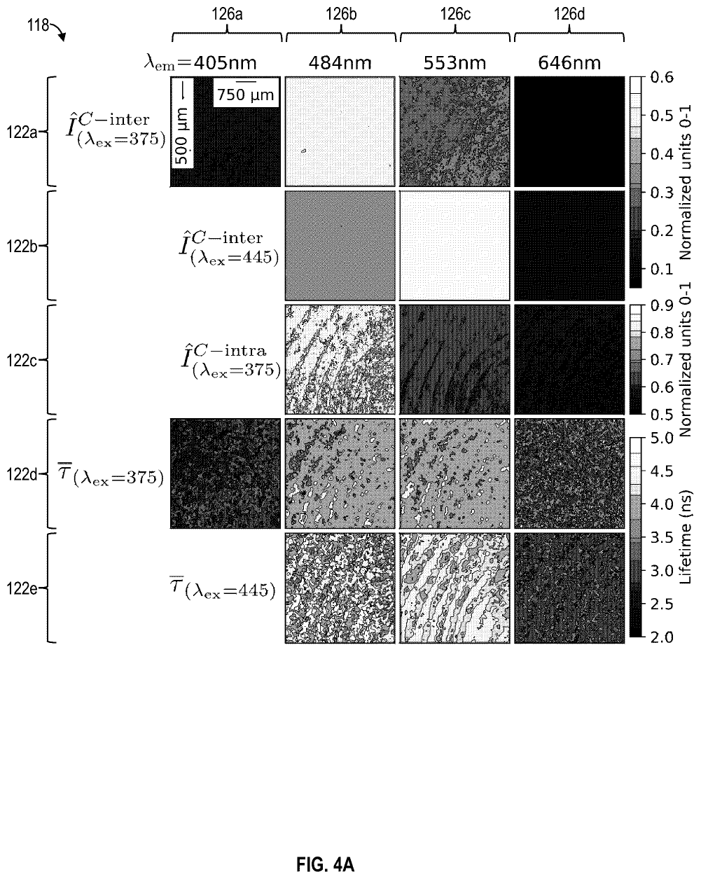

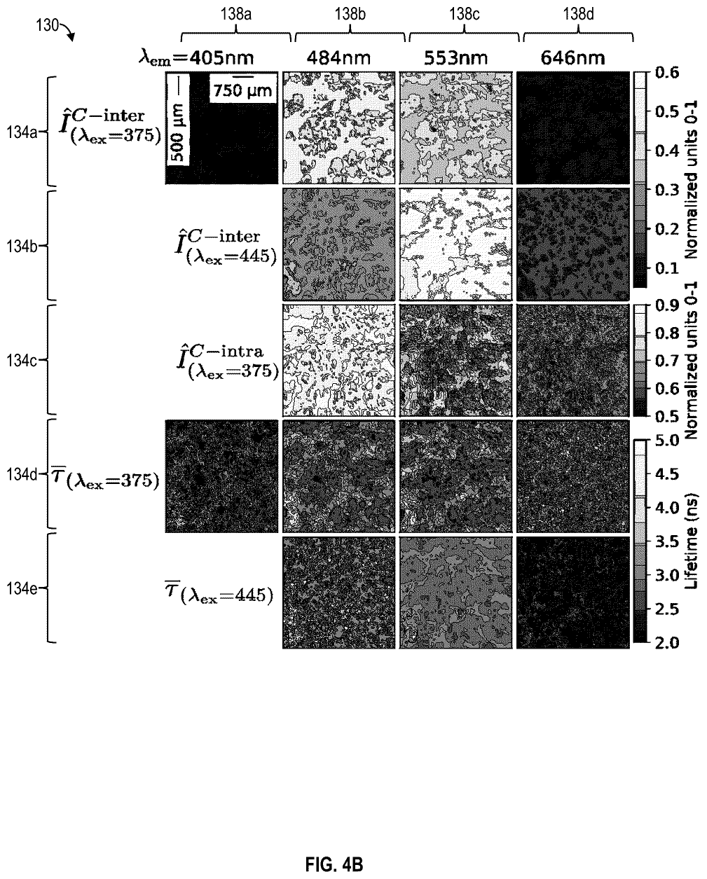

In vivo human finger skin and in vivo human tongue apex mucosa were imaged to demonstrate the FD-FLIM system's 10 ability to image endogenous fluorescence. Calibrated normalized intensity maps and average lifetime maps are shown in FIGS. 4A and 4B for human finger skin and human tongue mucosa, respectively. The background subtracted data D(λₑₘ, λₑₓ, y,x, f_{LT}^{ex}) was spatially averaged by a three by three pixel window before calculating the average lifetimes to improve signal quality. The calibrated normalized intensity maps were not spatially averaged.

FIG. 4A is an in vivo image 118 of human index-finger tip skin. Calibrated inter-channel intensities (Equation (4), Î_{(λ}_{ₑₘ}_{, λ}_{ₑₓ}_{, y, x)}^{C-inter}) are shown in the first row 122a (λₑₓ=375) and the second row 122b (λₑₓ=445). Calibrated intra-channel intensities (Equation (5), Î_{(λ}_{ₑₘ}_{, λ}_{ₑₓ}_{, y, x)}^{C-Intra}) are shown in the third row 122c (λₑₓ=375). Fluorescence average lifetime maps are shown in the fourth row 122d (λₑₓ=375) and the fifth row 122e (λₑₓ=445). Emission channels are organized in columns, with the center wavelength labeled at the top of the plots. The first column 126a corresponds to λₑₘ=405 nm, the second column 126b corresponds to λex=484 nm, the third column 126c corresponds to λₑₓ=553 nm, and the fourth column 126d corresponds to λₑₓ=646 nm.

The dual-excitation, multispectral FD-FLIM maps of the finger tip reflect the endogenous fluorophores (collagen, elastin, NADH, FAD) expected in human skin (see FIG. 4A). Collagen and elastin fluorescence emission is expected in the 405 nm band under 375 nm excitation, with average lifetimes of ˜2 ns for elastin and ˜4 ns for collagen. This is consistent with the Î_{(λ}_{ₑₓ}_{=375 nm)}^{C-inter} intensity and average lifetime (range: ˜2.5-3 ns) maps observed in the 405 nm band. Elastin, NADH, and FAD fluorescence emission is expected in both the 484 nm and 553 nm bands under 375 nm excitation, with average lifetimes of ˜4-5 ns for elastin, ˜0.5-2.5 ns for NADH, and ˜0.5-3 ns for FAD. This is also consistent with the Î_{(λ}_{ₑₓ}_{=375 nm)}^{C-inter} intensity and average lifetime (range: ˜3-4 ns) maps observed in both the 484 nm and 553 nm bands. None of these endogenous fluorophores emit at the 646 nm band under 375 nm excitation, which is consistent with the corresponding Î_{(λ}_{ₑₓ}_{=375 nm)}^{C-inter} intensity maps. Elastin and FAD fluorescence emission is expected in both the 484 nm and 553 nm bands under 445 nm excitation, with average lifetimes of ˜4-5 ns for elastin and ˜0.5-3 ns for FAD. This is also consistent with the Î_{(λ}_{ₑₓ}_{=375 nm)}^{C-inter} intensity and average lifetime (range: ˜3.5-4.5 ns) maps observed in both the 484 nm and 553 nm bands. Some FAD fluorescence emission is expected in the 646 nm band under 445 nm excitation, which is consistent with the average lifetime maps (range: a ˜2.5-3.5 ns) observed in the 646 nm band.

FIG. 4B is an in vivo image 130 of a human tongue mucosa. Calibrated inter-channel intensities (Equation (4), Î_{(λ}_{_{em,}}_{λ}_{ₑₓ}_{,y,)}^{C-inter}) are shown in the first row 134a (λₑₓ=375) and the second row 134b (λₑₓ=445). Calibrated intra-channel intensities (Equation (5), Î_{(λ}_{_{em,}}_{λ}_{ₑₓ}_{,y,)}^{C-intra}) are shown in the third row 134c (λₑₓ=375). Fluorescence average lifetime maps are shown in the fourth row 134d (λₑₓ=375) and the fifth row 134e (λₑₓ=445). Emission channels are organized in columns, with the center wavelength labeled at the top of the plots. The first column 138a corresponds to λₑₘ=405 nm, the second column 138b corresponds to λₑₓ=484 nm, the third column 138c corresponds to λₑₓ=553 nm, and the fourth column 138d corresponds to λₑₓ=646 nm.

The dual-excitation, multispectral FD-FLIM maps of the tongue apex reflect the endogenous fluorophores (collagen, NADH, FAD, porphyrin) expected in human oral mucosa (see FIG. 4B). Some collagen fluorescence emission is expected in the 405 nm band under 375 nm excitation. This is consistent with the Î_{(λ}_{ₑₓ}_{=375 nm)}^{C-inter} intensity and average lifetime maps observed in the 405 nm band, which show patches of tissue with both measurable fluorescence intensity and lifetime values of ˜3.5-4.5 ns. NADH and FAD fluorescence emission is expected in both the 484 nm and 553 nm bands under 375 nm excitation. This is consistent with the Î_{(λ}_{ₑₓ}_{=375 nm)}^{C-inter} intensity and average lifetime (range: ˜2.5-3.5 ns) maps observed in both the 484 nm and 553 nm bands. Some porphyrin fluorescence emission is expected in the 646 nm band under 375 nm excitation, with average lifetimes longer than ˜4 ns. This is consistent with the Î_{(λ}_{ₑₓ}_{=375 nm)}^{C-inter} intensity and average lifetime maps observed in the 646 nm band, which show patches of tissue with both measurable fluorescence intensity and lifetime values of ˜3-5 ns. FAD fluorescence emission is expected in both the 484 nm and 553 nm bands under 445 nm excitation. This is consistent with the Î_{(λ}_{ₑₓ}_{=375 nm)}^{C-inter} intensity and average lifetime (range: ˜2.5-3.5 ns) maps observed in both the 484 nm and 553 nm bands. Some FAD fluorescence emission is expected in the 646 nm band under 445 nm excitation, which is consistent with the average lifetime maps (range: ˜2-3 ns) observed in the 646 nm band.

### Instrumentation

We have implemented a versatile and practical FD-FLIM engine 14 capable of simultaneous multi-wavelength excitation, simultaneous multispectral detection, and sub-nanosecond to nanosecond fluorescence lifetime estimation. The engine 14 was developed using a single FPGA 76 programmed to provide all essential functionalities needed for FD-FLIM measurements, including laser modulation, optical scanning control, and time-resolved fluorescence signal digitization (via the digitizer 62). The FPGA 76 also provides real-time processing (i.e., DFT) of the digitized time-resolved fluorescence signal and Ethernet connectivity, thus enabling using the FD-FLIM engine 14 with a low-end desktop computer or laptop computer. Relative to the prior art, this updated design offers enhanced capabilities, while significantly reducing the FD-FLIM implementation complexity and cost.

In time-domain (TD) FLIM implementations, pulsed light sources are required for excitation. For TD-FLIM implementations based on time-correlated-single-photon-counting (TCSPC), single-photon excitation is achieved using pulsed light sources with low pulse-energy which are available and wavelengths spanning the UV-VI-NIR range. Multi-wavelength excitation TD-FLIM based on TCSPC, however, is not practical due to its innate high implementation cost and slow acquisition speed. Faster TD-FLIM implementations can be achieved using pulsed diode lasers 22 with high pulse-energy. The light sources, however, are costly and limited to a few available excitation wavelengths (e.g., 355 nm, 532 nm, 1064 nm), thus, unfitting for multi-wavelength excitation. In FD-FLIM implementation, frequency-modulated CW light sources can be used for excitation. CW light sources are less costly than pulsed light sources and also available in a selection of wavelengths spanning the UV-VI-NIR range (375-1064 nm). Multi-wavelength excitation FD-FLIM can thus be readily implemented using CW light sources modulated at frequencies that are not harmonically related, as demonstrated in the present disclosure.

Standard light excitation strategies in FD-FLIM are based on analog light modulation, in which the modulation frequency is swept over a frequency range spanning the expected bandwidth of the time-resolved fluorescence signal. Although the strategies enable estimating the entire fluorescence frequency response, they are innately slow. In our FD-FLIM implementation, a simple digital laser pulse modulation approach was adopted to enable faster imaging acquisition speed. The applied digital laser pulse modulation provides simultaneous frequency interrogation at the fundamental frequency and corresponding harmonics. Thus, the fluorescence frequency response is estimated only at a few discrete frequencies over a limited frequency range. Nevertheless, our rigorous validation experiments have demonstrated that fluorescence lifetimes can be estimated over a wide range (˜0.5 ns to >10 ns) from the fluorescence frequency response measured only at three discrete frequencies.

In TD-FLIM, the time-resolved fluorescence signal is measured with sub-nanosecond temporal resolution, thus requiring high-bandwidth (>1 GHz) photodetectors and electronics. In standard FD-FLIM implementations, the bandwidth requirements can be relaxed; however, sub-nanosecond lifetimes are typically measured using modulation frequencies in the 100s MHz. To further reduce the bandwidth requirements of our FD-FLIM engine 14, the laser digital modulation was restricted by design to frequencies below 100 MHz. This enables implementing cost-effective and practical FD-FLIM systems with simultaneous multispectral detection capabilities using low-cost, limited-bandwidth photodetectors and multi-channel digitizers. In spite of the limited bandwidth of our FD-FLIM engine 14, our rigorous validation experiments have demonstrated that fluorescence lifetimes as short as 0.5 ns can be simultaneously measured at multiple emission spectral bands.

Standard FD-FLIM implementations require measuring a reference signal to synchronize or demodulate the excitation and emission signals. This requirement increases the instrumentation complexity, particularly for multi-wavelength excitation, as additional optics, photodetectors, and/or digitizer input channels are needed to measure these references signals. In our FD-FLIM engine 14, the 250 MHz clock signals from the digitizer 62 are used to generate the digital modulation signals for the two diode lasers 22, and to sample the four spectrally separated fluorescence emission signals in the digitizer 62. The excitation/emission signal synchronization provided by the common clock simplifies our system instrumentation, as reference signals are not required to be measured. Instead, reference fluorophores with known lifetimes are imaged to measure the system frequency response needed for fluorescence lifetime estimation.

Although the lifetime resolving performance of our FD-FLIM implementation was comparable to prior art dual-excitation systems, our implementation has advantages that are targeted towards clinical imaging. The system described in the prior art required an interferometer and a spinning polygon mirror to generate excitation waveforms. While that approach resulted in superior modulation frequency coverage, its larger optical complexity would make clinical imaging more difficult. By contrast, our system 10 does not require additional optics to measure the fluorescence lifetime of multiple fluorophores excited simultaneously with different excitation wavelengths.

### Supplemental Information: Material and Methods

### Instrumentation

TABLE 2
Exemplary FD-FLIM system components of the above schematic.

| | |
|---|---|
| Host computer 18 | CPU: Ryzen 5 2600X |
| | RAM: G.SKILL Aegis DDR4 2400 4 × 16 GB (64 GB) |
| | Motherboard: ASUS Prime X370-A |
| Computing device 58 | Avnet Zedboard (Xilinx XC7Z020-CLG484-1) |
| Digitizer 62 | Abaco FMC104 (Single-Ended DC Coupling, 4-CH, 14-bit, 250 |
| | MS/s) |
| 375 nm Laser 22a | Toptica iBeam-Smar-375 |
| 445 nm Laser 22b | Toptica iBeam-Smart-445 |
| SMF (3.5 μm) 50 | Toptica Part No. OE-000592 (3.5 μm MFD, 0.07 NA) |
| L1 30a | Thorlabs C671TME-405 |
| DM1 34a | Chroma T3871p |
| L2 30b | Thorlabs C671TME-405 |
| DM2 34b | Chroma ZT442dcrb-UF1 |
| LPF1 42a | Semrock FF01-380/LP |
| MEMS Mirror 38 | Mirrorcle Technologies A8L2.2; 5 mm diameter, ±5° scan angle |
| L3 30c | Lens 12.5 mm diameter, 25 mm focal length, Edmund Optics 65-971 |
| L4 30d | Lens 12.5 mm diameter, 25 mm focal length, Edmund Optics 49-660 |
| MMF (200 μm) 54 | Thorlabs M92L02 |
| L5 30e | Thorlabs F220SMA-A |
| DM3 34c | Chroma AT440DC |
| BPF1 46a | Chroma ET405/40x |
| DM4 34d | Semrock FF506-Di03 |
| BPF2 46b | Semrock FF02-475/50 |
| LPF2 42b | Chroma AT4651p |
| DM5 34e | Semrock FF605-Di02 |
| BPF3 46c | Semrock FF01-550/88 |
| BPF4 46d | Semrock FF01-647/57 |
| APDs 26 | Hamamatsu C12702-11 |
| | Amplifier: Minicircuits ZFL-500LN+ |
| | High-Pass Filter: Minicircuits ZFHP-1R2-S+ |
| | Low-Pass Filter: Minicircuits BLP-90+ |
| | Power Supply (5 V) for all APDs: Meanwell RS-15-5 |
| | Power Supply (15 V) for all amplifiers: Meanwell RS-15-15 |

### Digitizer Interface

Synchronization of the laser control logic and the ADC sampling clocks was required for proper operation of the FD-FLIM system 10. However, unlike the prior art, both the digitization and laser control logic were located on the same FPGA 76.

Referring now to FIG. 5A, shown therein is a summary of the main clocking relationships between the digitizer 62 and the FPGA 76. Once the system 10 is powered on, the PS clock 142 of the PS 74 may be used to drive the digitizer interface 146 of the FPGA 76 to initialize the digitizer 62. In some embodiments, the PS clock 142 has a frequency of 100 MHz. The digitizer interface 146 may include a control clock 150 configured for a serial programmable interface (SPI). The control clock 150 may receive PS clock signals from the PS clock 142. The digitizer interface 146 may generate SPI clock signals and route the SPI clock signals from an SPI control output 156 to clocking circuitry 158 of the digitizer 62. The digitizer 62 may further include a plurality of analog inputs 169 wherein each of the analog inputs 169 corresponds to a particular one of the APDs 26 and a particular one of the ADCs 162. For purposes of clarity, only one of the analog inputs 169 is labeled with a reference character.

The digitizer's 62 clocking circuitry 158 may be configured to generate master clock signals and route the master clock signals to at least one of a plurality of analog-to-digital converters (ADCs) 162 (e.g., a first ADC (ADC0) 162a, a second ADC (ADC1) 162b, a third ADC (ADC2) 162c, and a fourth ADC (ADC3) 162d shown in FIG. 5A). In some embodiments, the master clock signals have a frequency of 250 MHz at each ADC 162. Each ADC 162 may receive data signals from the corresponding one of the analog inputs 169. In some embodiments, each ADC 162 may have one pair of clock lines and seven pairs of data lines. The ADCs 162 may be connected to the FPGA 76 via an FPGA mezzanine card (FMC) low pin count (LPC) connector (not shown). In some embodiments, the clock and data signals are provided to the FPGA 76 as low voltage differential signaling (LVDS) pairs.

The FPGA 76 may include a clocking block 175 which may receive the clock signals from ADC0 162a at a clock input 176 and use the clock signals to derive secondary clock signals for the acquisition and processing logic using the clocking block 175. In some embodiments, the clocking block 175 is an instance of the Xilinx Clocking Wizard v6.0. The clocking block 175 may generate first secondary clock signals (hereinafter, the “acquisition and processing clock signals”) and second secondary clock signals (hereinafter, the “delay control clock signals”), wherein the acquisition and processing clock signals may have a frequency of 125 MHz, and the delay control clock signals may have a frequency of 200 MHz. The acquisition and processing clock signals may be provided by a first clock output 177 to an acquisition clock input 179 of acquisition logic 180 and a processing clock input 181 of processing logic 182 of the FPGA 76. The delay control clock signals may be provided by a second clock output 178 to an I/O delay control block 184 of the digitizer interface 146. The I/O delay control block 184 may be configured to provide clock and data delay alignment for the digitizer interface 146. Although the delay control clock signals used for the I/O delay control block 184 may be generated from the clock signals of ADC0 162a, another clock source unrelated to the clock signals of the ADCs 162 could have been used.

In some embodiments, the acquisition logic 180 may convert the data and trigger data streams from the domains of the ADCs 162 into a 125 MHz clock domain for easier management and later data processing. Each ADC's 162 14-bit data and 1-bit trigger may be stored in a first-in-first-out (FIFO) memory at 250 MHz and read at twice the width (i.e., two 14-bit data points and two 1-bit trigger points) at 125 MHz. This converted the data stream from one data point (14-bit data, 1-bit trigger) at 250 MHz to two data points at 125 MHz. Then the digitized fluorescence emission was processed as described above.

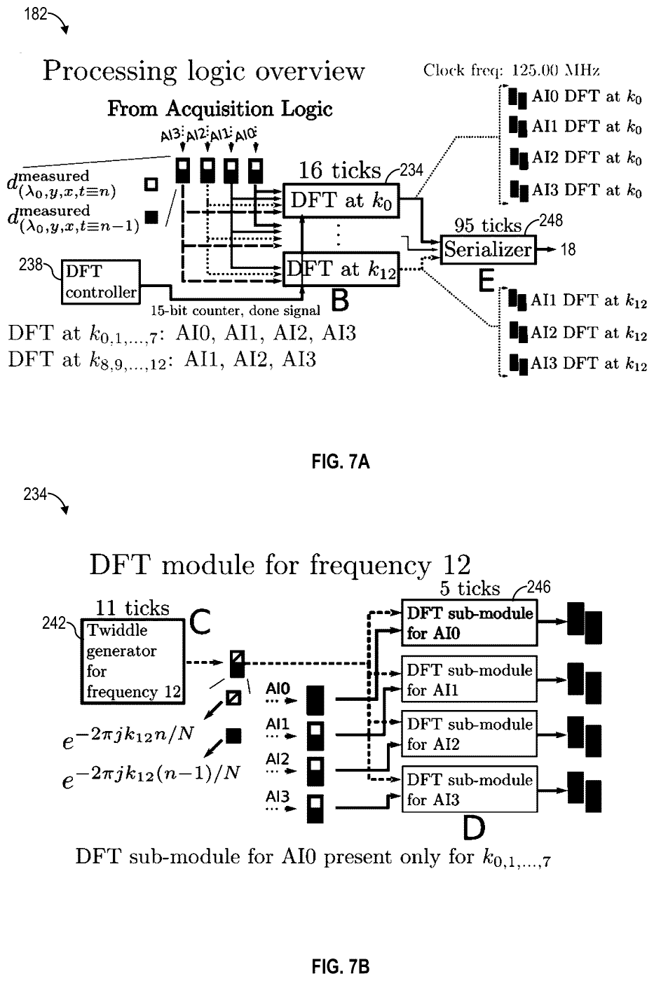

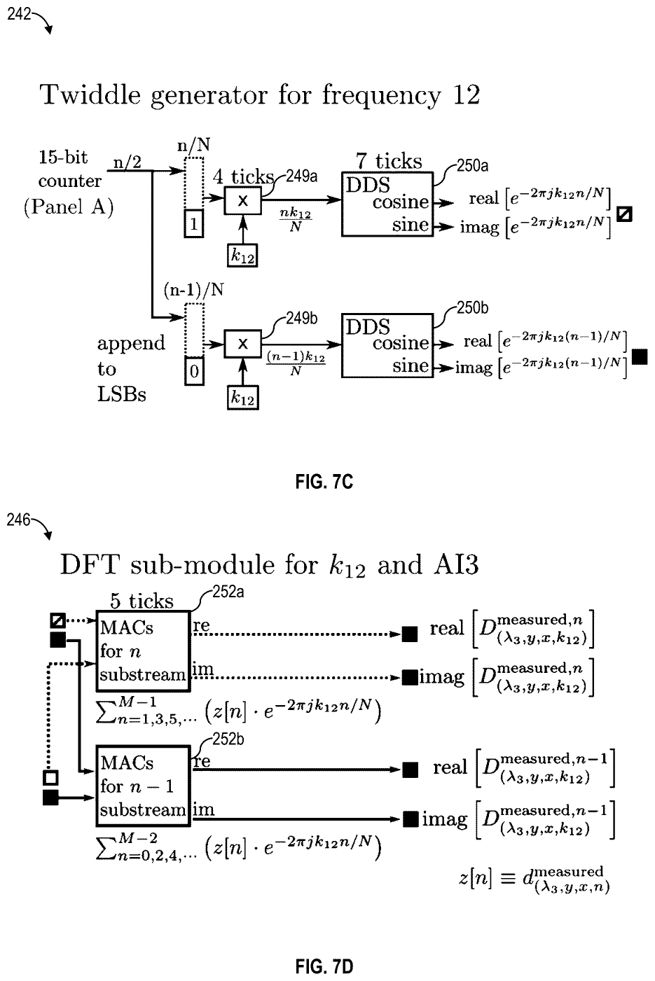

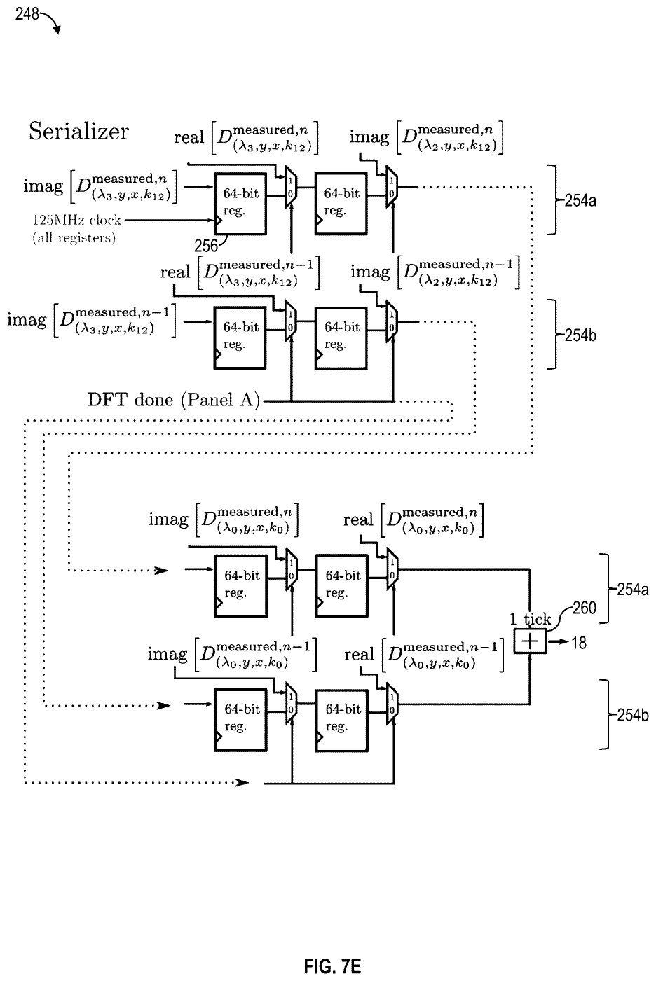

The processing logic 182 in FIG. 5A corresponds to the processing logic 182 shown in FIGS. 7A and 7B. In some embodiments, the data output by the processing logic 182 may have 128 bits.

The FPGA 76 may further comprise laser control logic 204. The laser control logic 204 may have a laser control clock 206. The laser control clock 206 may receive clock signals from ADC0 162. Further, the laser control logic 204 may have a trigger output 208 configured to provide trigger signals to an asynchronous trigger input 210 of the digitizer interface 146. In some embodiments, the clock signals received by the laser control clock 206 are 250 MHz clock signals.

Referring now to FIG. 5B, shown therein is logic used to acquire each input data bit. FIG. 5B shows a digitizer interface 146 in the FPGA 76 for acquiring one differential pair of data lines. The digitizer interface 146 for each ADC 162 may require one instance of the clock logic and trigger logic, and seven instances of the data logic. The name of each primitive is enclosed in angle brackets.

As discussed above, clock and data pins from each ADC 162 may be connected to FPGA pins via the FMC LPC slot on the computing device 58. One or more of the clock outputs 170 may have a positive clock output 170a and a negative clock output 170b, and one or more of the data outputs 174 may have a positive data output 174a and a negative data output 174b.

Input buffers 218 (<IBUFDS>) were used to bring the differential signals into the FPGA 76 fabric as single ended signals. The single ended ADC clock signal was connected to a global clock buffer 222 (<BUFG>), and the buffer output was used to drive the logic for sampling the ADC data and the internal trigger from the laser control logic 204. Each pair of ADC data bits was delayed by a delay element 226 (<IDELAYE2>) to match its latency to the given ADC's 162 clock signal for optimal sampling. We observed that all bits for all ADCs 162 could function with a delay element 226 (<IDELAYE2>) having a delay value of 25 out of 31. Delay tap values between 25 and 31 were acceptable as well. However, this delay amount is likely dependent on the computing device 58 and digitizer 62 quality control and may be different for future batches of equipment. Each delayed ADC data bit was converted from double data rate (DDR) to single data rate (SDR) by an input DDR register 230 (<IDDR>). Finally, the outputs for each ADC 162 from the digitizer interface 146 were: one trigger bit, one clock bit, and one 14-bit data number.

[ ].

### Laser Control Logic

The laser control logic 204 was driven with the clock from ADC0 162a via the output from the global clock buffer 222 for the ADC0 clock. However, the clock from any of the four ADCs 162 could have been used. The digital modulation signal for each diode laser 22 was generated with the pair of counters. Each counter was responsible for generating one fundamental square wave modulation frequency. One 8-bit counter was used for the intensity frequency, and one 5-bit counter was used for the lifetime frequency. Counters were incremented once per 250 MHz clock cycle until reaching a terminal count ctr_{(λ}_{ₑₓ}_{,i)}^{end}, where (λₑₓ, i) denotes the excitation wavelength and counter type i=INT, LT (intensity INT, or lifetime LT). Each counter resets its account to 0 after reaching ctr_{(λ}_{ₑₓ}_{,i)}^{end}. Thus, the output of each counter was of the form 0, 1, . . . , ctr_{(λ}_{ₑₓ}_{,i)}^{end}, 0, 1, . . . , etc. the output of each counter was connected to a comparator to set the duty cycle of the output square wave, ctr_{(λ}_{ₑₓ}_{,i)}^{duty}. An example is shown below.

$${ctr}_{( {λ}_{ex} , i )}^{end} = 3 \\ {ctr}_{( {λ}_{ex} , i )}^{duty} = 1 \\ Format : Time X = ( count , output ) \\ Time 0 = ( 0 , 1 ) \\ Time 1 = ( 1 , 1 ) \\ Time 2 = ( 2 , 0 ) \\ Time 3 = ( 3 , 0 ) \\ Time 4 = ( 0 , 1 ) \\ Time 5 = ( 1 , 1 )$$

The above example generates a pulse train with a period of four clock ticks and a 50% duty cycle. The intensity and lifetime counters for each laser's digital control signal were logically AND-ed before being output from the FPGA 76 to each diode laser 22 so that the diode laser 22 was only turned on when the intensity and lifetime counter outputs were both one.

In addition to the four counters used for the two digital modulation signals, one 16-bit counter was used to generate one lower frequency square wave to function as a pixel trigger. The pixel trigger was used to reset each digital modulation signal for each spatial pixel in a given FD-FLIM image. This forced the laser digital modulation signals to be identical for each spatial pixel. The pixel trigger was used to start data acquisition for each spatial pixel in the acquisition logic 180. The pixel trigger was an internal signal within the FPGA 76, and did not require any connection to the digitizer 62. The pixel trigger may be provided by the trigger output 208 of the laser control logic 204 to the asynchronous trigger input 210 of the digitizer interface 146.

### Modulation Frequency Selection

Modulation frequencies were chosen to be within the bandwidth of the system 10, to probe the lifetimes of the fluorophores of interest, to be producible by square wave excitation with the FPGA 76, to be sufficiently low to satisfy lifetime error constraints for f_{≈DC}^{ex}, and to avoid cross-talk between λₑₓ=375 nm and λₑₓ=445 nm modulation frequencies. Modulation frequencies should also be chosen to fall directly onto a multiple of the DFT frequency resolution

$$\frac{250 MHz}{{2}^{16}}$$

if possible. Excessively low f_{≈DC}^{ex} values were avoided because the amount of noise (1/f noise for example) was larger at lower frequencies.

The system bandwidth was limited to 100 MHz by the APDs 26. The digital laser control signals were generated with counters operating in a 250 MHz clock domain. Fundamental square wave modulation frequencies were limited to integer increments of the clock frequency

$$\frac{250 MHz}{x}$$

x=2,3,4, . . . , etc. The upper bound for f_{≈DC}^{ex} was set according to the fundamental lifetime frequency f_{LT}^{ex} to give less than approximately 0.1 ns of modulation lifetime τₘ error for a mono-exponential fluorophore with a 10 ns lifetime (see FIG. 5B). Endogenous fluorophores of interest (collagen, elastin, NADH, and FAD) do not have lifetime values longer than 10 ns. Lifetimes that are shorter than 10 ns have less relative τₘ error when using the DC approximation, so considering the longest lifetime was the most conservative case. Fundamental lifetime frequencies

$${f}_{LT}^{375} = \frac{250}{9} = 27.78 MHz and {f}_{LT}^{445} = \frac{250}{8} = 31.25 MHz$$

were chosen to give two harmonics that spanned the remainder of the 100 MHz system bandwidth f_{LT}^{ex}, 2 f_{LT}^{ex}, 3 f_{LT}^{ex}<100 MHz. We observed relatively low signal quality after the second harmonic, therefore we set f_{LT}^{ex} to give two additional harmonics in the 100 MHz system bandwidth.

Cross-talk between λₑₓ=375 nm and λₑₓ=445 nm was avoided exhaustively solving for combinations of (f_{≈DC}³⁷⁵, f_{LT}³⁷⁵) and (f_{LT}⁴⁴⁵) that did not have overlapping harmonic frequencies. Each digital laser control signal produced harmonics in addition to the two fundamental frequencies (f_{≈DC}^{ex}, f_{LT}^{ex}). Harmonics occurred at integer multiples of each fundamental intensity frequency f_{≈DC}^{ex}, 2 f_{≈DC}^{ex}, 3 f_{≈DC}^{ex}, etc., each lifetime frequency f_{LT}^{ex}, 2 f_{LT}^{ex}, 3 f_{LT}^{ex}, etc., and around each lifetime frequencies harmonic x f_{LT}^{ex}±yf_{≈DC}^{ex},x=1,2,3, etc.,y=1,2,3, etc. Frequency overlap was heuristically defined as any frequency from the other excitation wavelength being within 50 DFT frequency bins

$$( \frac{250 MHz}{{2}^{16}} \cdot 50 \approx 191 kHz )$$

of a used frequency. The frequencies used for 375 nm were compared with harmonics from 445 nm as shown below:
Frequencies used for 375 nm:

f_{≈DC}³⁷⁵,f_{LT}³⁷⁵,2f_{LT}³⁷⁵,3f_{LT}³⁷⁵

All 445 nm frequencies:

f_{≈DC}⁴⁴⁵,x·f_{LT}⁴⁴⁵±y·f_{≈DC}⁴⁴⁵
x=1,2,3
y=1,2,3, . . . ,10

The maximum value of y=10 was chosen heuristically with the assumption that unused harmonics would decay to insignificant amplitude after y=10. Overlap was determined similarly for λₑₓ=445 nm versus λₑₓ=375 nm. After overlap analysis, f_{≈DC}^{ex} values were chosen as:

$${f}_{\approx DC}^{375} = \frac{250 MHz}{137} \approx 1.82 MHz and {f}_{\approx DC}^{445} = \frac{250 MHz}{124} \approx 2.02 MHz .$$

### Data Processing—Theory

Before describing the data processing theory, it is useful to reiterate some equations listed above. The notation (λₑₘ, λₑₓ, y, x, f^{ex}) denotes emission band λₑₘ, excitation wavelength λₑₓ, image spatial coordinates y, x (assuming a 2D image), and modulation frequency f^{ex} (Hz) at the given λₑₓ. The Iₑₘ(λₑₘ,λₑₓ,y,x,f^{ex}), Iₑₓ(λₑₓ,y,x,f^{ex}), m(λₑₘ,λₑₓ,y,x,f^{ex}), and ϕ(λₑₘ,λₑₓ,y,x,f^{ex}) terms denote the fluorescence emission intensity, excitation intensity, modulation, and phase delay of the emission relative to the excitation, respectively.

$$\begin{matrix}{τ}_{ϕ ( {λ}_{em} , {λ}_{ex} , y , x , {f}^{ex} )} = \frac{1}{2 π {f}^{ex}} tan ( {ϕ}_{( {λ}_{em} , {λ}_{ex} , y , x , {f}^{ex} )} ) & ( 10 ) \\ {τ}_{m ( {λ}_{em} , {λ}_{ex} , y , x , {f}^{ex} )} = \frac{{I}_{em ( {λ}_{em} , {λ}_{ex} , y , x , {f}^{ex} )} \div {I}_{em ( {λ}_{em} , {λ}_{ex} , y , x , 0 )}}{{I}_{ex ( {λ}_{ex} , x , y , {f}^{ex} )} \div {I}_{ex ( {λ}_{ex} , y , x , 0 )}} & ( 11 ) \\ {τ}_{m ( {λ}_{em} , {λ}_{ex} , y , x , {f}^{ex} )} = \sqrt{( {( {m}_{( {λ}_{em} , {λ}_{ex} , y , x , {f}^{ex} )} )}^{- 2} - 1 ) {( 2 π {f}^{ex} )}^{- 2}} & ( 12 )\end{matrix}$$

Once the DFT is performed on the FPGA 76, the data (D_{(λ}_{ₑₘ}_{,λ}_{ₑₓ}_{,y,x,f}_{^{ex}}₎^{measured}) is sent to the host computer 18 over the communication network 70 to undergo more processing to remove system effects and to perform lifetime calculations. The first processing step on the host computer 18 is background subtraction. Background subtraction is performed as D_{(Δ}_{ₑₘ}_{,Δ}_{ₑₓ}_{,y,x,f}_{^{ex}})=D_{(λ}_{ₑₘ}_{,λ}_{ₑₓ}_{,y,f}_{^{ex}}₎^{measured}−D_{(λ}_{ₑₘ}_{,λ}_{ₑₓ}_{,f}_{^{ex}}₎^{background}. The background vector D_{(λ}_{ₑₘ}_{,λ}_{ₑₓ}_{, f}_{^{ex}}₎^{background} is obtained by averaging spatial pixels (y, x) in an image without anything at the sample position (also referred to as a blank image). The raw magnitude and phase are computed from the background subtracted data as I_{(λ}_{ₑₘ}_{,λ}_{ₑₓ}_{,f}_{^{ex}}₎^{measured}=|D_{(λ}_{ₑₘ}_{,λ}_{ₑₓ}_{,y,x,f}_{^{ex}}₎|, and ϕ_{(λ}_{ₑₘ}_{,λ}_{ₑₓ}_{,y,x,f}_{^{ex}}₎^{measured}=∠D_{(Δ}_{ₑₘ}_{,Δ}_{ₑₓ}_{,y,x,f}_{^{ex}}₎, respectively. The magnitude and phase operations are defined as |x|=((real(x))²+(imag(x))²)^{0.5} and ∠(x)=arctan 2(imag(x), real(x)), respectively. The real(x) and imag(x) operations take the real and imaginary parts of the complex number x. The magnitude and phase may be computed with the Python3 Numpy functions numpy.absolute and numpy.angle, respectively.

FD-FLIM system calibration of magnitude data I_{(λ}_{ₑₘ}_{,λ}_{ₑₓ}_{,y,x,f}_{^{ex}}₎^{measured} consists of DC approximation and normalization. DC approximation uses the magnitude at a relatively low frequency f_{≈DC}^{ex} to approximate the magnitude at 0 Hz (required by Equation 11) because the APDs 26 and amplifiers and the system 10 are AC coupled: I_{(λ}_{ₑₘ}_{,λ}_{ₑₓ}_{,y,x,f}_{_{≈DC}}_{^{ex}}₎^{measured}. The f_{≈DC}^{ex} was set high enough to be within the system's 10 bandwidth and low enough so that the fluorophores of interest exhibited insignificant modulation (see the “Supplemental Information” section below for more information). Normalization constants C_{(λ}_{ₑₘ}_{,λ}_{ₑₓ}_{,f}_{^{ex}}₎^{norm} correct for unequal power at each modulation frequency due to the digital square wave excitation, as the Equation 11 for modulation assumes that the excitation power at each modulation frequency is equal in the later excitation waveforms. Reference fluorophores with known lifetimes are used to calculate C_{(λ}_{ₑₘ}_{,λ}_{ₑₓ}_{,f}_{^{ex}}₎^{norm}. The modulation of the reference fluorophore data measured with the FD-FLIM system 10 with DC approximation is denoted as m_{(λ}_{ₑₘ}_{,λ}_{ₑₓ}_{,f}_{^{ex}}₎^{measured ref}=I_{(λ}_{ₑₘ}_{,λ}_{ₑₓ}_{,y,X,f}_{^{ex}}₎^{measured ref}÷I_{(λ}_{ₑₘ}_{,λ}_{ₑₓ}_{,y,x,f}_{_{≈DC}}_{^{ex}}₎^{measured ref}. The expected modulation of the reference fluorophore m_{(λ}_{ₑₘ}_{,λ}_{ₑₓ}_{,f}_{^{ex}}₎^{true ref} is calculated using the known lifetime of the fluorophore and Equation 12. Then the normalization constants are calculated as C_{(λ}_{ₑₘ}_{,λ}_{ₑₓ}_{,f}_{^{ex}}₎^{norm}=m_{(λ}_{ₑₘ}_{,λ}_{ₑₓ}_{,f}_{^{ex}})^{true ref}÷m_{(λ}_{ₑₘ}_{, λ}_{ₑₓ}_{,f}_{^{ex}}₎^{measured ref}. The corrected modulation is denoted as m_{(λ}_{ₑₘ}_{,λ}_{ₑₓ}_{,y,x,f}_{^{ex}}₎ as shown below in Equation 13.

$${m}_{( {λ}_{em} , {λ}_{ex} , y , x , {f}^{ex} )} = {C}_{( {λ}_{em} , {λ}_{ex} , {f}^{ex} )}^{norm} \cdot \frac{{I}_{( {λ}_{em} , {λ}_{ex} , y , x , {f}^{ex} )}^{measured}}{{I}_{( {λ}_{em} , {λ}_{ex} , y , x , {f}_{\approx DC}^{ex} )}^{measured}} \qquad ( 13 )$$

Phase calibration is performed by subtracting ϕ_{(λ}_{ₑₘ}_{,λ}_{ₑₓ}_{,y,x,f}_{^{ex}}₎^{measured} from the measured system phase ϕ_{(λ}_{ₑₘ}_{, λ}_{ₑₓ}_{,f}_{^{ex}}₎^{system} to remove delays due to optics and electronics. The ϕ_{(λ}_{ₑₘ}_{, λ}_{ₑₓ}_{,f}_{^{ex}}₎^{system} is calculated by imaging reference fluorophores with the FD-FLIM system 10. The phase of the reference fluorophores acquired with the FD-FLIM system 10 is denoted as ϕ_{(λ}_{ₑₘ}_{, λ}_{ₑₓ}_{,f}_{^{ex}}₎^{measured ref}. The expected phase of the reference fluorophores is calculated from the known lifetimes and Equation 10, ϕ_{(λ}_{ₑₘ}_{, λ}_{ₑₓ}_{,f}_{^{ex}}₎^{true ref}. The corrected phase delay is denoted as ϕ_{(λ}_{ₑₘ}_{,λ}_{ₑₓ}_{,y,x,f}_{^{ex}}₎ As shown below in Equation 14.

$${ϕ}_{( {λ}_{em} , {λ}_{ex} , y , x , {f}^{ex} )} = ( {ϕ}_{( {λ}_{em} , {λ}_{ex} , {f}^{ex} )}^{measured ref} - {ϕ}_{( {λ}_{em} , {λ}_{ex} , {f}^{ex} )}^{true ref} ) - {ϕ}_{( {λ}_{em} , {λ}_{ex} , y , x , {f}^{ex} )}^{measured} \qquad ( 14 )$$

The relative fluorescence intensity in each emission band provides information about the fluorescence emission spectrum of the image sample, in addition to the fluorescence lifetime. The normalized inter-channel intensity, Î_{(λ}_{ₑₓ}_{,λ}_{ₑₓ}_{,y,x)}^{inter}, is defined as shown below in Equation 15.

$${\hat{I}}_{( {λ}_{em} , {λ}_{ex} , y , x )}^{inter} = \frac{{I}_{( {λ}_{em} , {λ}_{ex} , y , x , {f}_{\approx DC}^{ex} )}^{measured}}{{\sum }_{{λ}_{em}} {I}_{( {λ}_{em} , {λ}_{ex} , y , x , {f}_{\approx DC}^{ex} )}^{measured}} \qquad ( 15 )$$

The normalized intra-channel intensity, Î_{(λ}_{ₑₘ}_{,λ}_{ₑₓ}_{,y,x)}^{intra}, for a given (λₑₘ, λₑₓ) is defined as shown below in Equation 16.

$${\hat{I}}_{( {λ}_{em} , {λ}_{ex} , y , x )}^{intra} = \frac{{I}_{( {λ}_{em} , {λ}_{ex} , y , x , {f}_{\approx DC}^{ex} )}^{measured}}{{\sum }_{{λ}_{ex}} {I}_{( {λ}_{em} , {λ}_{ex} , y , x , {f}_{\approx DC}^{ex} )}^{measured}} \qquad ( 16 )$$

The inter-channel normalized intensity quantifies the intensity between each λₑₘ for a given λₑₓ, and the intra-channel normalized intensity quantifies the intensity within each λₑₘ for a given λₑₓ.

Intensities I_{(λ}_{ₑₘ}_{,λ}_{ₑₓ}_{,y,x,f}_{_{≈DC}}_{^{ex}}₎^{measured} were calibrated to remove the effect of differing APD gains and optics transmission spectra on each emission channel λₑₘ (inter-channel intensity calibration). The intensities were also corrected for differing laser powers and laser control waveforms (intra-channel intensity calibration).

The inter-channel intensity calibration factors are denoted as C_{(λ}_{ₑₘ}₎^{inter}, and consist of two calibration steps C_{(λ}_{ₑₘ}₎^{inter:optics} and C_{(λ}_{ₑₘ}₎^{inter:APD gains}. The optics correction C_{(λem)}^{inter:optics} scales the optics transmission spectra to be one within the center and FWHM of each emission channel. C_{(λ}_{ₑₘ}₎^{inter:optics} compensate for losses in each emission channel due to optics other than the emission channel's BPF 46. The APD gains correction C_{(λ}_{ₑₘ}₎^{inter:APD gains} compensates for different APD gains between emission channels.

The process of calculating C_{(λ}_{ₑₘ}₎^{inter:optics} is explained below. First, the transmission spectrum of each emission channel was computed using the vendors' online data T_{(λ}_{ₑₘ}_{,λ′)}^{DMs,BPFs} where λ′ denotes a particular wavelength within the given λₑₘ. The centers and FWHMs of the four emission channels were 405/35 nm, 484/37 nm, 553/93 nm, and 646/69 nm. These four emission channels are also referred to as channel 1, 2, 3, and 4, respectively. Then, T_{(λ}_{ₑₘ}_{,λ′)}^{Ideal} calculated from T_{(λ}_{ₑₘ}_{,λ′)}^{DMs,BPFs} by thresholding each emission channel λₑₘ to be one within its center

$$\pm \frac{FWHM}{2} .$$

For example, the transmission spectrum for channel 3 was calculated by multiplying the transmission of DM1 34a, DM2 34b, LPF1 42a, DM3 34c, DM4 34d, BPF3 46c, and the reflectance of DM5 34e. The resulting channel 3 center and FWHM was 553/93 nm. The ideal transmission spectra for λₑₘ=553/93 nm was set to one in the wavelength range 506.5 nm≤λ′≤599.5 nm, and set to zero otherwise. The C_{(λem)}^{inert:optics} correction constants were calculated as shown below in Equation 17.

$${C}_{( {λ}_{em} )}^{inter : optics} = \frac{{Σ}_{λ} , {T}_{( {λ}_{em} , λ′ )}^{Ideal}}{{Σ}_{λ} , {T}_{( {λ}_{em} , λ′ )}^{DMs , BPFs}} \qquad ( 17 )$$

The APD gain correction constants C_{(λ}_{ₑₘ}₎^{inter:APD gains} were calculated using the spectra of reference fluorophores Spectra_{(λ}_{ₑₓ}_{,λ′)}^{ref} acquired with a spectrometer (e.g., USB4000 manufactured by Ocean Optics), and images from the same fluorophores acquired with the FD-FLIM system 10. All pixels of fluorophores data acquired with the FD-FLIM system 10 were averaged before calculating the C_{(λ}_{ₑₘ}₎^{inter:APD gains} values. POPOP in ethanol was used as the reference fluorophore for calibrating emission channels 1-2-3. Rose bengal in PBS was used as the reference fluorophore for calibrating emission channels 3-4. Spectrometer data was acquired by setting the 375 nm laser 22a to have a constant output power (not modulated), by disabling the 445 nm laser 22b, and by connecting the output of LMF5 54e (located between L4 30d and L5 30e in the system 10 shown in FIG. 1) to the spectrometer instead of L5 30e. Then, the same reference fluorophores solutions were imaged with the FD-FLIM system 10. The Spectra_{(λ}_{ₑₓ}_{,λ′)}^{ref} was multiplied by T_{(λ}_{ₑₘ}_{,λ′)}^{DMs,BPFs} and summed for each channel to compute the expected intensities:

$${I}_{( {λ}_{em} , {λ}_{ex} = 375 nm )}^{expected : POPOP} = {Σ}_{λ} , ( {Spectra}_{( {λ}_{ex} = 375 nm , λ′ )}^{POPOP} \cdot {T}_{( {λ}_{em} , λ′ )}^{DMs , BPFs} ) , and {I}_{( {λ}_{em} , {λ}_{ex} = 375 nm )}^{expected : rose bengal} = {Σ}_{λ} , ( {Spectra}_{( {λ}_{ex} = 275 nm , λ′ )}^{rose bengal} \cdot {T}_{( {λ}_{em} , λ′ )}^{DMs , BPFs} ) .$$

Then, Equation 15 was applied to calculate the expected inter-channel intensities I_{(λ}_{ₑₘ}_{,λ}_{ₑₓ}_{=375 nm)}^{expected:POPOP} The APD gain correction constants C_{(λ}_{ₑₘ}₎^{inter:APD gains} for the first three emission channels scaled the FD-FLIM system POPOP inter-intensities so that they were equal to the expected POPOP inter-channel intensities.

$${\hat{I}}_{( {λ}_{em} , {λ}_{ex} = 375 nm )}^{expected : POPOP} = {C}_{( {λ}_{em} )}^{inter : APD gains} \cdot {\hat{I}}_{( {λ}_{em} , {λ}_{ex} = 375 nm )}^{inter : system : POPOP} \\ {λ}_{em}^{for POPOP} = 405 / 35 nm , 484 / 37 nm , 553 / 93 nm$$

Similarly, rose bengal was used to calculate C_{(λ}_{ₑₘ}₎^{inter:APD gains} for the last two channels.

$${\hat{I}}_{( {λ}_{em} , {λ}_{ex} = 375 nm )}^{expected : rose bengal} = {C}_{( {λ}_{em} )}^{inter : APD gains} \cdot {\hat{I}}_{( {λ}_{em} , {λ}_{ex} = 375 nm )}^{inter : system : rose bengal} \\ {λ}_{em}^{for rose bengal} = 553 / 93 nm , 646 / 69 nm$$

The two sets of APD gain correction constants calculated from POPOP and rose bengal were divided by the channel 3 (λₑₘ=553/93 nm) constants. Once the APD gain correction constants were one in channel 3, they could be merged to obtain C_{(λ}_{ₑₘ}₎^{iner:APD gains} for all four spectral channels. While the C_{(λ}_{ₑₘ}₎^{inter:optics} corrections are calculated once and reused, the C_{(λ}_{ₑₘ}₎^{inter:APD gains} corrections are calculated for each imaging session. In addition to the C_{(λ}_{ₑₘ}₎^{inter:optics} and C_{(λ}_{ₑₘ}₎^{inter:APD gains} corrections, the intensities are also divided by the FWHMs of each emission channel BW(λₑₘ) to give the average intensity in each emission channel. The final inter-intensity calibration constant calculation is summarized below in Equation 18.

$${C}_{( {λ}_{em} )}^{inter} = \frac{{C}_{( {λ}_{em} )}^{inter : optics} \cdot {C}_{( {λ}_{em} )}^{inter : APD gains}}{{BW}_{( {λ}_{em} )}} \qquad ( 18 )$$

The intra-channel intensity calibration factors are denoted as C_{(λ}_{ₑₘ}₎^{intra}. Calibration is performed using two groups of data: B1 intensity-only data, and B2 data from the FD-FLIM system 10 with default configuration. Data from group B1 is acquired once, and data from group B2 is acquired once per imaging session as part of the reference fluorophore data that is also used for lifetime calibrations. The two groups B1 and B2 do not need to be from the same FD-FLIM system 10. For example, B1 data was acquired from an FD-FLIM system 10 at a laboratory at the University of Oklahoma, while B2 data was acquired by another FD-FLIM system 10 with the same optics, electronics, and fluorophore solution at a clinic location. The fluorophore solutions for B1 and B2 do not need to have identical concentrations as long as the emission spectra is the same.

Data for B1 was acquired as follows. First, the powers of the 375 nm laser 22a and the 445 nm laser 22b were set to be equal at the sample position using a power meter (S120VC sensor with PM100D consol, Thorlabs). Then, rose bengal in PBS was imaged twice, first with only 375 nm excitation enabled D_{(λ}_{ₑₘ}_{,λ}_{ₑₓ}_{=375 nm,y,x,f=1 MHz)}^{measured:rose bengal 375 nm only}, and second with only 445 nm excitation enabled D_{(λ}_{ₑₘ}_{,λ}_{ₑₓ}_{=375 nm,y,x,f=1 MHz)}^{measured:rose bengal 445 nm only}. The same 1 MHz square waveform was used as the digital modulation signal for both diode lasers 22. Then the data from the two images was combined into one image using the 375 nm data from the 375 nm only one image and the 445 nm data from the 445 nm only image: D_{(λ}_{ₑₘ}_{,λ}_{ₑₓ}_{=375 nm,y,x,f=1 MHz)}^{measured:rose bengal}=D_{(λ}_{ₑₘ}_{,λ}_{ₑₓ}_{=375 nm,y,x,f=1 MHz)}^{measured:rose bengal 375 nm only} and D_{(λ}_{ₑₘ}_{,λ}_{ₑₓ}_{=375 nm,y,x,f=1 MHz)}^{measured:rose bengal 445 nm only}. This B1 data gave the true intra-channel intensity of rose bengal in PBS when the excitation powers and laser control waveforms are identical. Equation 16 was applied to give the true intra-channel intensity Î_{(λ}_{ₑₘ}_{, λ}_{ₑₓ}_{,y,x)}^{inter:rose bengal:true} This B1 data was saved as a reference to calibrate future data sets from the FD-FLIM system 10.

Data for B2 consists of one image of rose bengal in PBS with the FD-FLIM system 10 under normal conditions (both intensity approximation f_{≈DC}^{ex} and lifetime f_{LT}^{ex} frequencies present in the laser digital modulation signals): D_{(λ}_{ₑₘ}_{,λ}_{ₑₓ}_{,y,x)}^{measured:rose bengal:uncalibrated}. Equation 16 is applied to give the system intra-channel intensity: Î_{(λ}_{ₑₘ}_{,λ}_{ₑₓ}_{,y,x)}^{intra:rose bengal:system}.

The intra-channel intensity calibration constants C_{(λ}_{ₑₘ}₎^{intra} are calculated as shown below in Equation 19. All spatial pixels (x, y) containing rose bengal were averaged before calculating C_{(λ}_{ₑₘ}₎^{intra}. The third emission channel is used to calculate the calibration constants because it contains the largest rose bengal emission intensity from both the 375 nm and 445 nm excitation sources.

$${C}_{( {λ}_{em} )}^{intra} = \frac{{\hat{I}}_{( {λ}_{em} = 553 / 93 nm , {λ}_{ex} )}^{intra : rose bengal : true}}{{\hat{I}}_{( {λ}_{em} = 553 / 93 nm , {λ}_{ex} )}^{intra : rose bengal : system}} \qquad ( 19 )$$

The final calibrated intensities are shown below.

$${I}_{( {λ}_{em} , {λ}_{ex} , y , x , {f}_{\approx DC}^{ex} )}^{calibrated} = {C}_{( {λ}_{em} )}^{intra} \cdot {C}_{( {λ}_{em} )}^{inter} \cdot {I}_{( {λ}_{em} , {λ}_{ex} , y , x , {f}_{\approx DC}^{ex} )}^{measured} \qquad ( 20 )$$

The normalized calibrated inter-channel and intra-channel intensities are computed from the calibrated intensities by applying Equation 15 and Equation 16, respectively.

$$\begin{matrix}{\hat{I}}_{( {λ}_{em} , {λ}_{ex} , y , x )}^{C - inter} = \frac{{I}_{( {λ}_{em} , {λ}_{ex} , y , x )}^{calibrated}}{{Σ}_{{λ}_{em}} {I}_{( {λ}_{em} , {λ}_{ex} , y , x )}^{calibrated}} & ( 21 ) \\ {\hat{I}}_{( {λ}_{em} , {λ}_{ex} , y , x )}^{C - intra} = \frac{{I}_{( {λ}_{em} , {λ}_{ex} , y , x )}^{calibrated}}{{Σ}_{{λ}_{ex}} {I}_{( {λ}_{em} , {λ}_{ex} , y , x )}^{calibrated}} & ( 22 )\end{matrix}$$

### DFT Module Implementation

An overview of the DFT implementation shown in FIG. 7A. The DFT is computed at eight modulation frequencies across all four emission channels AI0-AI3 for 375 nm excitation, and at five modulation frequencies across the last three emission channels AI1-AI3 for 445 nm excitation.

The four channels of analog fluorescence emission signals from the APDs 26 are digitized at a rate of 250 MS/s with 14-bit resolution by the digitizer 62. The digitized fluorescence emission from the four digitizer analog inputs, AI0 to AI3 (i.e., ADC0 162a to ADC3 162d), are read by the acquisition logic 180 and sent to the DFT modules 234. For purposes of clarity, only one of the DFT modules 234 is labeled with a reference character. The fluorescence emission channels are connected to the following analog inputs: 405/35 nm to AI0, 484/37 nm to All, 553/93 nm to AI2, and 646/69 nm to AI3. All four analog input channel AI0-AI3 are inputted to DFT modules 234 k₀-k₇, and All-AI3 are inputted to DFT modules 234 k₈-k₁₂. The DFT controller 238 provides a 15-bit counter and a DFT done signal to the remainder of the DFT logic. The 15-bit counter value is used in the twiddle generator 242 (shown in FIG. 7B) for all DFT modules 234. The counter was implemented in FPGA 76 fabric and did not use any DSP slices. The DFT done signal is used to reset the accumulators in all DFT sub-modules 246 (shown in FIG. 7B), and as a load signal in the serializer 248.

Referring now to FIG. 7B, shown therein is an expanded view of the DFT module 234 for k₁₂. Each DFT module 234 computes the DFT at one frequency for multiple emission channels, and consists of one twiddle generator 242 and several DFT sub-modules 246 (one per emission channel). For purposes of clarity, only one of the DFT sub-modules 246 is labeled with a reference character.

Referring now to FIG. 7C, shown therein is the twiddle generator 242 consisting of two multipliers 249a and 249b (e.g., Xilinx Multiplier 12.0) and two direct digital synthesizers (DDS) 250a and 250b (e.g., DDS, Xilinx DDS complier 6.0). Each multiplier 249 was implemented in one of two ways: using one digital signal processing (DSP) slice, or using general purpose FPGA 76 fabric (LUTs and FFs). Each DDS 250 consumes three DSP slices and 1×18 k BRAM. One twiddle generator 242 produces the sine and cosine terms (twiddle factors) for the DFT at a given frequency index (k₁₂ in this example).

Referring now to FIG. 7D, shown therein is the DFT sub-module 246 consisting of two multiply accumulators (MACs) 252a and 252b (e.g., Xilinx DSP48 Macro 3.0). The DFT sub-module 246 multiplies and accumulates (MACs) the twiddle factors and the digitized fluorescence emission for a given pixel of the FD-FLIM data stream.

Each MAC 252 was implemented in one of two ways, in one DSP slice or in FPGA 76 fabric. In the DSP implementation, the DSP48 Macro 3.0 was configured with two instructions 0: P+A*B and 1: A*B, where 0 and 1 is the DFT done signal from the DFT controller 238. In the FPGA 76 fabric MAC implementation, the Xilinx Multiplier 12.0 may be used as a multiplier, and a separate adder may be implicitly implemented in VHDL. After the DFT controller's 238 counter reaches the terminal M value of the DFT, the DFT done signal may be asserted for one clock cycle, causing the accumulator in the MAC 252 to reset and await input data from the next DFT cycle. The DSP and fabric implementations options allowed for maximizing the amount of DFT modules 234 that could fit on the computing device 58. The following strategy was used when creating the DFT design on the FPGA 76: (1) DFT modules 234 implemented purely with DSPs were included in the design until all DSPs on the FPGA 76 were exhausted, (2) parts of the DFT modules 234 were changed to their fabric implementations and more DFT modules 234 were included (keeping maximum DSP usage) until the FPGA 76 code failed to compile due to resource overmapping or timing violations. The DSP and fabric configuration of each DFT module 234 is described in the caption of Table 3. A total of 13 DFT modules 234 (k₀-k₁₂) may be compiled on the FPGA 76.

### DFT Serializer

Referring now to FIG. 7E, shown therein is the serializer 248 located after the DFT processing logic 182 on the FPGA 76. The serializer 248 adds each n data stream 254a and n−1 data stream 254b and converts the parallel outputs of all DFT modules 234 into one serial data stream. Then the serialized DFT data is transferred to the host computer 18 via the communication network 70. The latency in clock cycles (ticks) is shown above each element. The total latency of the DFT processing logic 182 is 111 ticks of the 125 MHz clock, or 888 ns.

The serializer 248 is responsible for converting the parallel outputs of all DFT modules 234 into one serial data stream. The serializer 248 consists of one 64-bit register 256 per real and imaginary number output of the DFT modules 234. Only the first and last real and imaginary pairs of data registers 256 are shown for brevity. For purposes of clarity, only one of the data registers 256 is labeled with a reference character. All registers 256 are loaded when the DFT done signal is asserted (see FIG. 7A). Then the real and imaginary parts are shifted to the adder 260 that combines the n data stream 254a and the n−1 data stream 254b into one data stream. Finally, the output of the adder 260 is transferred into the onboard RAM and then to the host computer 18 over the communication network 70 by the PS 74. Each register 256 has a latency of one tick, and the final adder 260 has a latency of one tick (shown above the + symbol).

### FPGA Resource Usage

Table 3. FPGA 76 resource usage summary. The design of the FPGA 76 was also compiled without the DFT processing logic 182 for comparison purposes. Each resource is listed on a row with the total number present on the FPGA 76 in parenthesis, and the percentage used for each of the processing and no processing designs. DFT modules 234 for k₀-k₃ consumed 24 DSP slices as all multipliers 249 and MACs 252 were implemented in fabric. One multiplier 249 in the DFT module 234 for k₄ was implemented in fabric, using a total of 23 DSP slices. Math logic for the remaining k₅-k₁₂ DFT modules 234 was implemented entirely with DSP slices, using 172 DSP slices. A total of 219 out of the total 220 DSP slices in the FPGA 76 were used by the DFT logic. One DSP slice was used in the acquisition logic 180 to generate portions of the MEMS scanning waveform.

| | Processing | No processing |
|---|---|---|
| | (%) | (%) |
| LUT (53200) | 73.02 | 25.73 |
| FF (106400) | 57.91 | 22.54 |
| BRAM (140) | 47.86 | 38.57 |
| DSP (220) | 100.00 | 0.45 |

Table 4. Digital signal processor (DSP) slice and Block RAM (BRAM) usage for various DFT logic components described herein and shown in FIGS. 7C and 7D. The first column is the IP name, and the second column is the DSP usage assuming a pure DSP implementation.

| Schematic name (FIGS. 7A-7D) | Resource |
|---|---|
| Multiplier (X) | 1 DSP |
| DDS | 3 DSP |
| | 1 × 18k |
| | BRAM |
| MAC | 1 DSP |
| DFT sub-module | 4 DSP |
| Twiddle gen. | 8 DSP |
| | 2 × 18k |
| | BRAM |
| DFT module (375 nm) | 24 DSP |
| | 2 × 18k |
| | BRAM |
| DFT module (445 nm) | 20 DSP |
| | 2 × 18k |
| | BRAM |

The DFT implementation in the FPGA 76 is capable of calculating eight DFTs across all four analog inputs AI0-AI3 for λₑₓ=375 nm and five DFTs across AI1-AI3 for λₑₓ=445 nm. One DFT frequency for each excitation wavelength is used for the DC approximation (k₀ for λₑₓ=445 nm and k₈ for λₑₓ=445 nm). The remaining DFT frequencies could be used for lifetime calculations: 7(k₁-k₇) for λₑₓ=375 nm and 4(k₉-k₁₂) for λₑₓ=445 nm. However, the range and number of frequencies that can be practically used for lifetime calculations will also depend on: the frequency response of the fluorescent sample 12 being imaged, bandwidth of the FD-FLIM system 10 (e.g., 100 MHz), the power frequency distribution of the modulated excitation light, and the signal quality of the fluorescence emission (excitation light power, fluorescence emission collection efficiency, etc.). The relatively short fluorescence lifetimes of NADH and FAD (0.5 ns to 3 ns) necessitated the use of as much of the 100 MHz system bandwidth is possible. The digital square wave modulation of the diode lasers 22 results in more power at the fundamental frequency (f_{LT}^{ex}) and decreasing power at each successive harmonic frequency (2f_{LT}^{ex}, 3f_{LT}^{ex}, etc.). Furthermore, the 250 MHz FPGA 76 laser control clock 206 limited the minimum pulse with (and therefore the duty cycle adjustment of the square wave) to 4 ns. We observed that the fluorescence emission signal quality was low after the third harmonic in the current system configuration when imaging in vivo human skin and oral cavity tissue. Taking all these factors into consideration, the 13 DFT frequencies were set as follows: k₀ for f_{≈DC}³⁷⁵, k₁ for f_{LT}³⁷⁵, k₂ for 2f_{LT}³⁷⁵, k₃ for 3f_{LT}³⁷⁵, k₄ to k₇ for noise, k₈ for f_{≈DC}⁴⁴⁵, k₉ for f_{LT}⁴⁴⁵, k₁₀ for 2f_{LT}⁴⁴⁵, k₁₁ for 3f_{LT}⁴⁴⁵, for k₁₂ for noise. The DFT modules k₄, k₅, k₆, k₇, and k₁₂ our such two frequencies that did not have any fluorescence emission. These noise frequencies were used to quantify signal-to-noise ratio, but are not discussed further in the present disclosure.

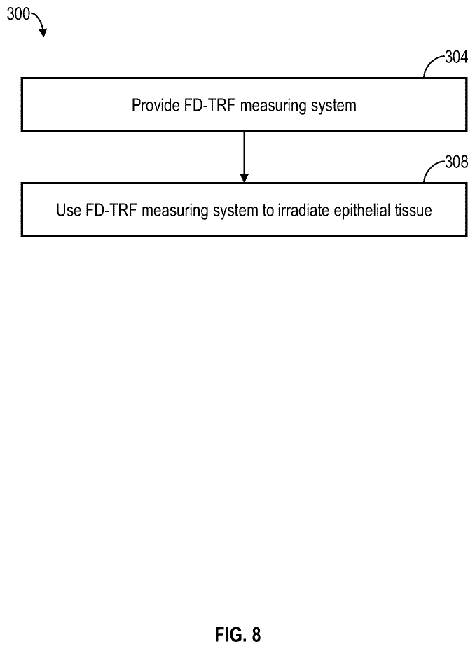

Referring now to FIG. 8, shown therein is an exemplary method 300 of analyzing an epithelial tissue (i.e., a sample 12) in accordance with the present disclosure. As shown in FIG. 8, the method 300 generally comprises the steps of: providing a FD-TRF measuring system 10, wherein the FD-TRF measuring system 10 comprises one or more FM CW digital-pulse modulated diode laser 22 configured for simultaneous multiwavelength excitation of one or more compound 12 and one or more light emission detector (i.e., APDs 162) configured for simultaneous multispectral time-resolved fluorescence measurement of a FFR of the one or more compound 12, wherein the excitation occurs at wavelengths within a frequency range of less than 100 MHz, wherein the one or more diode laser 22 is configured to emit excitation at wavelengths spanning a set of frequencies which comprises at least three different frequencies in a range between 1 to 99 MHz, the set comprising at least one frequency <50 MHz, and at least one frequency ≥50 MHz and <100 MHz (step 304); and using the FD-TRF measuring system 10 to irradiate an epithelial tissue 12 to determine if a cancer is present in the epithelial tissue 12 (step 308).

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred embodiment. Further, the phrase “based on” is intended to mean “based, at least in part, on” unless explicitly stated otherwise.

What is claimed is:

1. A multispectral frequency-domain time-resolved fluorescence (FD-TRF) measuring system, comprising:
at least one frequency-modulated (FM) continuous wave (CW) digital-pulse modulated diode laser configured for simultaneous multiwavelength excitation of at least one compound; and
at least one light emission detector configured for simultaneous multispectral time-resolved fluorescence measurement of a fluorescence frequency response (FFR) of the at least one compound, wherein the excitation is modulated at frequencies within a frequency range of less than 100 MHz, wherein the at least one diode laser is configured to emit modulated excitation spanning a set of frequencies which comprises at least three different frequencies in a range between 1 to 99 MHz, the set comprising at least one frequency <50 MHz, and at least one frequency ≥50 MHz and <100 MHz.

2. The FD-TRF measuring system of claim 1, wherein the set of frequencies comprises 3 to 10 different frequencies.

3. The FD-TRF measuring system of claim 1, wherein the set of frequencies comprises 3 to 5 different frequencies.

4. The FD-TRF measuring system of claim 1, wherein each frequency in the set of frequencies is separated by at least 10 MHz.

5. The FD-TRF measuring system of claim 1, wherein each frequency in the set of frequencies is separated by at least 5 MHz.

6. The FD-TRF measuring system of claim 1, wherein the set of frequencies comprises at least two frequencies <50 MHz, and at least one frequency ≥50 MHz and <100 MHz.

7. The FD-TRF measuring system of claim 1, wherein the set of frequencies comprises at least one frequency <50 MHz, and at least two frequencies ≥50 MHz and <100 MHz.

8. The FD-TRF measuring system of claim 1, wherein the set of frequencies comprises at least two frequencies <50 MHz, and at least two frequencies ≥50 MHz and <100 MHz.

9. The FD-TRF measuring system of claim 1, wherein the set of frequencies comprises three different frequencies, the set comprising one frequency <50 MHz, and two frequencies ≥50 MHz and <100 MHz.

10. The FD-TRF measuring system of claim 1, wherein the set of frequencies comprises four different frequencies, the set comprising two frequencies <50 MHz, and two frequencies ≥50 MHz and <100 MHz.

11. The FD-TRF measuring system of claim 1, wherein the set of frequencies comprises at least one frequency <40 MHz, at least one frequency ≥40 MHz and <70 MHz, and at least one frequency ≥70 MHz and <100 MHz.

12. The FD-TRF measuring system of claim 1, wherein the set of frequencies comprises at least one frequency <30 MHz, at least one frequency ≥30 MHz and <50 MHz, at least one frequency ≤51 MHz and <75 MHz, and at least one frequency ≥76 MHz and <100 MHz.

13. The FD-TRF measuring system of claim 1, wherein the set of frequencies comprises three to five different frequencies, the set comprising at least one frequency <40 MHz, at least one frequency ≥40 MHz and <70 MHz, and at least one frequency ≥70 MHz and <100 MHz.

14. The FD-TRF measuring system of claim 1, wherein the system comprises time-resolved fluorescence spectroscopy (TRFS).

15. The FD-TRF measuring system of claim 1, wherein the system comprises fluorescence lifetime imaging endoscopy.

16. The FD-TRF measuring system of claim 1, wherein the system comprises fluorescence lifetime imaging microscopy (FLIM).

17. The FD-TRF measuring system of claim 16, wherein the FLIM is a handheld device.

18. The FD-TRF measuring system of claim 17, wherein the handheld device comprises an enclosure and a probe, and wherein the enclosure comprises a pair of galvanometric mirrors for scanning, dichroic mirrors for combining excitation beams and separating fluorescence emission, and fiber collimators and mirrors for alignment, and the probe comprises a pair of achromatic lenses which form a relay system, and a third achromatic lens which functions as an objective lens which provides a field of view (FOV).

19. A method of irradiating a biological sample, comprising:
providing a multispectral frequency-domain time-resolved fluorescence (FD-TRF) measuring system comprising at least one frequency-modulated (FM) continuous wave (CW) digital-pulse modulated diode laser configured for simultaneous multiwavelength excitation of at least one compound, and at least one light emission detector configured for simultaneous multispectral time-resolved fluorescence measurement of a fluorescence frequency response (FFR) of the at least one compound, wherein the excitation occurs at wavelengths within a frequency range of less than 100 MHz, wherein the at least one diode laser is configured to emit excitation at wavelengths spanning a set of frequencies which comprises at least three different frequencies in a range between 1 to 99 MHz, the set comprising at least one frequency <50 MHz, and at least one frequency ≥50 MHz and <100 MHz;
irradiating the biological sample with the FD-TRF measuring system; and
analyzing the FFR received from the biological sample.

20. The method of claim 19, wherein the FD-TRF measuring system comprises a handheld device.
